(19) United States
(12) Patent Application Publication
(10) Pub. No.: US 2025/0167311 A1
(43) Pub. Date: May 22, 2025

(54) Battery Pack Comprising Internally Connected Bipolar Electrodes and Manufacturing Method

(71) Applicant: Honeycomb Battery Company, Dayton, OH (US)

(72) Inventor: Bor Z. Jang, Centerville, OH (US)

(73) Assignee: Honeycomb Battery Company, Dayton, OH (US)

(21) Appl. No.: 18/518,118

(22) Filed: Nov. 22, 2023

(51) Int. Cl. H01M 10/42; H01M 4/02; H01M 4/04; H01M 4/131; H01M 4/133; H01M 4/1391; H01M 4/1393; H01M 4/525; H01M 4/587; H01M 10/0525; H01M 10/056; H01M 10/058; H01M 50/383; H01M 50/426; H01M 50/434; H01M 50/446

(52) U.S. Cl. CPC H01M 10/4235; H01M 4/0404; H01M 4/131; H01M 4/133; H01M 4/1391; H01M 4/1393; H01M 4/525; H01M 4/587; H01M 10/0525; H01M 10/056; H01M 10/058; H01M 50/383; H01M 50/426; H01M 50/434; H01M 50/446; H01M 2004/029; H01M 2300/0085; H01M 2300/0094

(57) ABSTRACT

A bipolar battery pack comprising one or a plurality of modules wherein at least one module comprises a set of multiple bipolar electrodes internally connected in series, wherein the bipolar electrode comprises: (a) a current collector; (b) a positive electrode layer, disposed on one primary surface, comprising a mixture of particles of a cathode active material and a hybrid electrolyte comprising a mixture of an inorganic solid-state electrolyte and a solid polymer electrolyte or gel polymer electrolyte, and (c) either a negative electrode layer deposited on the opposing primary surface or initially without a negative electrode layer, wherein the multiple bipolar electrodes are connected in series in such a manner that an ion-permeable separator or solid-state electrolyte layer is disposed between the negative electrode layer of a bipolar electrode and the positive electrode layer of a neighboring bipolar electrode. Multiple modules can be connected in parallel.

### FIELD

The present invention provides bipolar electrodes, a bipolar lithium battery module or pack containing multiple bipolar electrodes connected in series and/or in parallel, and manufacturing methods for the bipolar electrode and the bipolar battery pack.

### BACKGROUND

Rechargeable lithium-ion (Li-ion) and lithium metal batteries (e.g., lithium-sulfur, lithium selenium, and Li metal-air batteries) are considered promising power sources for electric vehicle (EV), hybrid electric vehicle (HEV), and portable electronic devices, such as lap-top computers and mobile phones. Lithium as a metal element has the highest lithium storage capacity (3,861 mAh/g) compared to any other metal or metal-intercalated compound as an anode active material (except Li_{4.4}Si, which has a specific capacity of 4,200 mAh/g). Hence, in general, Li metal batteries (having a lithium metal anode) have a significantly higher energy density than lithium-ion batteries (having a graphite anode).

However, the electrolytes used for lithium-ion batteries and all lithium metal secondary batteries pose some safety concerns. Most of the organic liquid electrolytes can cause thermal runaway or explosion problems.

Ionic liquids (ILs) are a new class of purely ionic, salt-like materials that are liquid at unusually low temperatures. The official definition of ILs uses the boiling point of water as a point of reference: “Ionic liquids are ionic compounds which are liquid below 100° C.”. A particularly useful and scientifically interesting class of ILs is the room temperature ionic liquid (RTIL), which refers to the salts that are liquid at room temperature or below. RTILs are also referred to as organic liquid salts or organic molten salts. An accepted definition of an RTIL is any salt that has a melting temperature lower than ambient temperature.

Although ILs were suggested as a potential electrolyte for rechargeable lithium batteries due to their non-flammability, conventional ionic liquid compositions have not exhibited satisfactory performance when used as an electrolyte likely due to several inherent drawbacks: (a) ILs have relatively high viscosity at room or lower temperatures; thus being considered as not amenable to lithium ion transport; (b) For Li—S cell uses, ILs are capable of dissolving lithium polysulfides at the cathode and allowing the dissolved species to migrate to the anode (i.e., the shuttle effect remains severe); and (c) For lithium metal secondary cells, most of the ILs strongly react with lithium metal at the anode, continuing to consume Li and deplete the electrolyte itself during repeated charges and discharges. These factors lead to relatively poor specific capacity (particularly under high current or high charge/discharge rate conditions, hence lower power density), low specific energy density, rapid capacity decay and poor cycle life. Furthermore, ILs remain extremely expensive. Consequently, as of today, no commercially available lithium battery makes use of an ionic liquid as the primary electrolyte component.

Solid state electrolytes are commonly believed to be safe in terms of fire and explosion proof. Solid state electrolytes can be divided into organic, inorganic, organic-inorganic composite electrolytes. However, the conductivity of organic polymer solid state electrolytes, such as poly(ethylene oxide) (PEO), polypropylene oxide (PPO), poly(ethylene glycol) (PEG), and poly(acrylonitrile) (PAN), is typically low (<10⁻⁵ S/cm).

Although the inorganic solid-state electrolyte (e.g., garnet-type and metal sulfide-type) can exhibit a high conductivity (about 10⁻³ S/cm), the interfacial impedance or resistance between the inorganic solid-state electrolyte and the electrode (cathode or anode) is high. Further, the traditional inorganic ceramic electrolyte is very brittle and has poor film-forming ability and poor mechanical properties. These materials cannot be cost-effectively manufactured. Although an organic-inorganic composite electrolyte can lead to a reduced interfacial resistance, the lithium ion conductivity and working voltages may be decreased due to the addition of the organic polymer.

The applicant's research group has previously developed the quasi-solid state electrolytes (QSSE), which may be considered as a fourth type of solid state electrolyte. In certain variants of the quasi-solid state electrolytes, a small amount of liquid electrolyte may be present to help improving the physical and ionic contact between the electrolyte and the electrode, thus reducing the interfacial resistance. Examples of QSSEs are disclosed in the following: Hui He, et al. “Lithium Secondary Batteries Containing a Non-flammable Quasi-solid Electrolyte,” U.S. patent application Ser. No. 13/986,814 (Jun. 10, 2013); U.S. Pat. No. 9,368,831 (Jun. 14, 2016); U.S. Pat. No. 9,601,803 (Mar. 21, 2017); U.S. Pat. No. 9,601,805 (Mar. 21, 2017); U.S. Pat. No. 9,059,481 (Jun. 16, 2015).

In a related topic, bipolar batteries include lithium batteries that consist of internally stacked electrodes connected in series. In contrast to conventional lithium-ion batteries, these electrodes have a “bipolar” current collector structure. This means that the active materials for the cathode of the battery and the active materials for the anode are applied to the opposing primary surfaces of a current collector or common electrode carrier. The individual lithium-ion cells are then no longer packed separately in aluminum housings, but only the finished electrode stack (or a multi-cell battery module or pack) is given a fixed housing. This significantly reduces or eliminates the need for housing components and connecting cables, which saves costs and space in an electric vehicle. The reduced amount of connecting wires or cables results in a lower internal resistance and higher power. The space freed up can be filled with more active material. This allows the battery to store more energy and increases the vehicle's range. This is an attractive feature of lithium-ion bipolar batteries. A stringent condition for a bipolar battery to work is having an electrolyte not being allowed to migrate from one battery cell to another. This condition has essentially eliminated the use of a liquid electrolyte.

Hence, a general object of the present invention is to provide a safe, flame/fire-resistant, quasi-solid or solid-state electrolyte system for a rechargeable bipolar lithium battery module or pack. Safe bipolar unit cells are internally connected in series to form a module and multiple modules are internally connected in parallel to form a pack. This electrode-to-module or electrode-to-pack strategy eliminates the need to make multiple cells first that are then externally connected to form a higher voltage module or pack using excessive amounts of connectors, welds, casings, etc.

### SUMMARY

The present disclosure provides a bipolar battery pack comprising one or a plurality of modules wherein at least one module comprises a first set of multiple bipolar electrodes internally connected in series, wherein at least one of the bipolar electrodes comprises:
a) A current collector comprising a conductive material foil having a thickness from 10 nm to 100 μm and two opposing primary surfaces;
b) a positive electrode (cathode) layer disposed on one of the two primary surfaces (also herein referred to as a first primary surface), wherein the positive electrode layer comprises a mixture of particles of a cathode active material, an optional but typically desired conductive additive, an optional binder resin, and a first hybrid electrolyte comprising a mixture of an inorganic solid-state electrolyte and a solid polymer electrolyte or gel polymer electrolyte, wherein the solid polymer or gel polymer electrolyte comprises a polymer, having a lithium ion conductivity no less than 1.0×10⁻⁸ S/cm, which is a product prepared by partially or totally removing a first solvent from a polymer solution originally comprising a polymer and a lithium salt dissolved in the first solvent having a polymer-to-lithium salt weight ratio of from 1/100 to 100/1; and
c) either (i) a negative electrode layer deposited on the opposing primary surface (also herein referred to as the second primary surface) wherein the negative electrode layer comprises a lithium metal layer or a mixture of particles of an anode active material, a solid polymer electrolyte or gel polymer electrolyte, and, optionally, particles of a solid inorganic solid-state electrolyte wherein the solid or gel polymer comprises a lithium salt dispersed therein with a polymer-to-lithium salt weight ratio of from 1/100 to 100/1 or (ii) initially without a negative electrode layer deposited on said opposing primary surface (so-called “anodeless”) when the battery pack is made (a lithium metal layer is formed when the battery pack is charged);
wherein the multiple bipolar electrodes are connected in series in such a manner that an ion-permeable separator or solid-state electrolyte layer is disposed between the negative electrode layer of a bipolar electrode and the positive electrode layer of a neighboring bipolar electrode.

In certain preferred embodiments, the bipolar battery pack preferably comprise multiple sets (modules) of multiple bipolar electrodes internally connected in series and these multiple sets (modules) of multiple bipolar electrodes are internally connected in parallel. Preferably, the bipolar battery pack further comprises a protecting housing that encloses the multiple modules. There can be partitioning walls between internally arranged modules, if so desired.

In some preferred embodiments, the solid polymer or gel polymer electrolyte and the inorganic solid-state electrolyte, in combination, form a contiguous phase in the cathode, in the anode, or in both the anode and the cathode, and the contiguous phase is in a physical contact or ionic communication with the ion-permeable separator or solid-state electrolyte layer.

In certain embodiments, one or both of the primary surfaces of the conductive material foil (e.g., Al foil, Cu foil, stainless steel cell, etc.) is coated with a layer of graphene or expanded graphite sheets having a layer thickness from 1 nm to 50 μm. This could prevent lithium diffusion in the metal foil, which otherwise could degrade the function of a bipolar electrode Alternatively, this conductive foil contains a laminate of two or more conductive materials laminated together. For instance, this can contain a layer of Cu (for supporting the negative electrode layer) and a layer of Al (for supporting the positive electrode layer) that are mechanically compressed or chemically bonded together. This can also be a Cu foil or Al foil coated with a layer of conductive polymer (e.g., an intrinsically conductive polymer or a polymer matrix containing conductive fillers dispersed therein; examples of conductive fillers being graphene sheets, carbon nanotubes, carbon fibers, carbon black particles, etc.).

In the bipolar pack, the solid polymer electrolyte or gel polymer electrolyte preferably comprises a polymer selected from poly(ethylene oxide), polypropylene oxide, polyoxymethylene, polyvinylene carbonate, polypropylene carbonate, poly(ethylene glycol), poly(acrylonitrile), poly(methyl methacrylate), poly(vinylidene fluoride), poly bis-methoxy ethoxyethoxide-phosphazenex, polyvinyl chloride, polydimethylsiloxane, poly(vinylidene fluoride)-hexafluoropropylene, cyanoethyl poly(vinyl alcohol), a pentaerythritol tetra-acrylate-based polymer, an aliphatic polycarbonate, a single Li-ion conducting solid polymer, poly(ethylene glycol) diacrylate, poly(ethylene glycol) methyl ether acrylate, polyurethane, polyurethane-urea, polyacrylamide, a polyionic liquid, polymerized 1,3-dioxolane, polyepoxide ether, polysiloxane, poly(acrylonitrile-butadiene), polynorbornene, poly(hydroxyl styrene), poly(ether ether ketone), polypeptoid, poly(ethylene-maleic anhydride), polycaprolactone, poly(trimethylene carbonate), polyphosphate, polyphosphonate, polyphosphinate, polyphosphine, polyphosphine oxide, a polymer synthesized from an ionic liquid, a copolymer thereof, a semi-penetrating network thereof, a sulfonated derivative thereof, or a combination thereof.

In some embodiments, the inorganic solid electrolyte is selected from an oxide type, sulfide type, hydride type, halide type, borate type, phosphate type, lithium phosphorus oxynitride (LiPON), garnet-type, lithium superionic conductor (LISICON) type, sodium superionic conductor (NASICON) type, or a combination thereof.

In some embodiments, the first liquid solvent is selected from the group consisting of 1,2-dimethoxyethane (DME), tetraethylene glycol dimethylether (TEGDME), poly(ethylene glycol) dimethyl ether (PEGDME), diethylene glycol dibutyl ether (DEGDBE), 2-ethoxyethyl ether (EEE), sulfone, sulfolane, dimethyl carbonate (DMC), methylethyl carbonate (MEC), ethyl propionate, methyl propionate, propylene carbonate (PC), gamma.-butyrolactone (γ-BL), acetonitrile (AN), ethyl acetate (EA), propyl formate (PF), methyl formate (MF), toluene, xylene, methyl acetate (MA), fluoroethylene carbonate (FEC), vinylene carbonate (VC), allyl ethyl carbonate (AEC), vinylene carbonate, ethylene carbonate, fluoroethylene carbonate, vinyl sulfite, vinyl ethylene sulfite, vinyl ethylene carbonate, 1,3-propyl sultone, 1,3-acrylic-sultones, methyl ethylene sulfone, methyl vinyl sulfone, ethyl vinyl sulfone, methyl methacrylate, vinyl acetate, acrylamide, 1,3-dioxolane (DOL), fluorinated ethers, fluorinated esters, sulfones, sulfides, nitriles, sulfates, siloxanes, silanes, phosphates, phosphonates, phosphinates, phosphines, phosphine oxides, phosphonic acids, phosphorous acid, phosphites, phosphoric acids, phosphazene compounds, derivatives thereof, and combinations thereof.

In some embodiments, the positive electrode layer comprises a mixture of particles of a cathode active material, a conductive additive, and the first hybrid electrolyte comprising a mixture of an inorganic solid-state electrolyte and a solid polymer electrolyte or gel polymer electrolyte, wherein the solid polymer or gel polymer electrolyte comprises a polymer, which is a product prepared by partially or totally removing the first solvent from a polymer solution originally comprising a polymer and a lithium salt dissolved in the first solvent having a polymer-to-lithium salt weight ratio of from 1/100 to 100/1. However, the negative electrode layer may comprise a lithium metal layer or a layer of a mixture of particles of an anode active material and a second hybrid electrolyte, wherein the second hybrid electrolyte comprises a mixture of particles of an inorganic solid electrolyte, an optional binder resin, an optional conductive additive, and a second polymer electrolyte which meets one of the following two criteria: (A) the second polymer electrolyte is a product prepared by partially or totally removing a second solvent from a polymer solution originally comprising a second polymer and a lithium salt dissolved in the second liquid solvent having a polymer-to-lithium salt weight ratio of from 1/100 to 100/1; or (B) the second polymer is a polymerization or crosslinking product of a reactive additive, wherein the reactive additive comprises (i) a third liquid solvent that is polymerizable, (ii) an initiator or curing agent, and (iii) a lithium salt, wherein this polymerizable liquid solvent occupies from 1% to 99% by weight of the total weight of the reactive additive, wherein the polymerizable liquid solvent is the same as or different from the first liquid solvent; wherein the second hybrid electrolyte is the same as or different from the first hybrid electrolyte.

The positive electrode layer or the negative electrode layer may further comprise a second liquid solvent and the first liquid solvent has a lower flash point, a higher vapor pressure, a higher dielectric constant, or a higher solubility of the lithium salt as compared with the second liquid solvent.

Preferably, the first liquid solvent or the second liquid solvent comprises a flame retardant selected from an organic phosphorus compound, an inorganic phosphorus compound, a halogenated derivative thereof, or a combination thereof. The organic phosphorus compound or the inorganic phosphorus compound is selected from the group consisting of phosphates, phosphonates, phosphonic acids, phosphorous acids, phosphites, phosphoric acids, phosphinates, phosphines, phosphine oxides, phosphazene compounds, derivatives thereof, and combinations thereof.

In some embodiments, the negative electrode layer comprises a lithium metal layer. This lithium metal layer may comprise a lithium foil, lithium particles, protected lithium particles, etc. This lithium metal layer may be absent when the bipolar electrode or the resultant bi-polar lithium battery is made and prior to the first battery charge. After the bipolar battery is charged, the primary surface at the anode side is deposited with a layer of lithium metal whose constituent lithium metal elements come from the cathode side.

In some embodiments, the second liquid solvent (the same as or different than the first liquid solvent) is selected from the group consisting of vinylene carbonate, ethylene carbonate, fluoroethylene carbonate, vinyl sulfite, vinyl ethylene sulfite, vinyl ethylene carbonate, 1,3-propyl sultone, 1,3-acrylic-sultones, methyl ethylene sulfone, methyl vinyl sulfone, ethyl vinyl sulfone, methyl methacrylate, vinyl acetate, acrylamide, 1,3-dioxolane (DOL), fluorinated ethers, fluorinated esters, sulfones, sulfides, nitriles, sulfates, siloxanes, silanes, phosphates, phosphonates, phosphinates, phosphines, phosphine oxides, phosphonic acids, phosphorous acid, phosphites, phosphoric acids, phosphazene compounds, derivatives thereof, and combinations thereof. Some of these solvents (e.g., vinylene carbonate, ethylene carbonate) tend to have a relatively low flash points, high flammability, but good ability to dissolve a lithium salt.

In the conventional lithium-ion battery or lithium metal battery, the liquid solvents listed above are commonly used as a solvent to dissolve a lithium salt therein and the resulting solutions are used as a liquid electrolyte. These liquid solvents have a relatively high dielectric constant and, hence, are capable of dissolving a high amount of a lithium salt. These liquid solvents can be used to dissolve both a lithium salt and a polymer having an ion conductivity greater than 10⁻⁸ S/cm to form a polymer solution. The polymer solution may be impregnated into pores of a dry cathode (positive electrode) or anode (negative electrode) making contact with the cathode or the anode active material and with particles of an inorganic solid electrolyte. By removing the liquid solvent, one obtains a polymer electrolyte (along with an inorganic electrolyte to form a hybrid electrolyte or composite electrolyte).

Alternatively, one can polymerize the liquid solvent once the liquid electrolyte (having a lithium salt dissolved in the first liquid solvent) is mixed into an electrode (an anode active layer or a cathode active layer, for instance). With such a novel strategy, one can readily reduce the liquid solvent or completely eliminate the volatile liquid solvent all together. A desired amount of a second liquid solvent, preferably a flame-resistant liquid solvent, may be retained in the battery cell to improve the lithium ion conductivity of the electrolyte, if so desired. This strategy enables us to achieve several desirable attributes of the resultant electrolyte: no liquid electrolyte leakage issue (the in situ cured polymer being capable of holding the remaining liquid together to form a gel), adequate lithium salt amount, good lithium ion conductivity, reduced or eliminated flammability, good ability of the electrolyte to wet on anode/cathode active material surfaces (hence, significantly reduced interfacial impedance and internal resistance), processing ease, compatibility with current lithium-ion battery production processes and equipment, etc. This is of significant utility value since most of the organic solvents are known to be volatile and flammable, posing a fire and explosion danger and current solid-state electrolytes are not compatible with existing lithium-ion battery manufacturing equipment and processes. In the present bipolar electrode-based bipolar lithium battery, the electrolyte will not migrate from one unit cell to another; this is a necessary condition for a bipolar battery.

In certain embodiments, the first or the second liquid solvent is selected from the group consisting of fluorinated ethers, fluorinated esters, sulfones, sulfides, nitriles, sulfates, siloxanes, silanes, combinations thereof, and combinations with phosphates, phosphonates, phosphinates, phosphines, phosphine oxides, phosphonic acids, phosphorous acid, phosphites, phosphoric acids, phosphazene compounds, derivatives thereof, and combinations thereof.

Preferably, the lithium salt occupies 0.1%-50% by weight and the crosslinking agent and/or initiator occupies 0.1-50% by weight of the reactive additive.

In certain embodiments, the reactive additive (e.g., for the production of the negative electrode layer) comprises a polymerizable first liquid solvent and a second liquid solvent and wherein the second liquid solvent either is not polymerizable or is polymerizable but polymerized to a lesser extent as compared to the first liquid solvent. The presence of this second liquid solvent is designed to impart certain desired properties to the polymerized electrolyte, such as lithium ion conductivity, flame retardancy, and the ability of the electrolyte to permeate into the electrode (anode and/or cathode) to properly wet the surfaces of the anode active material and/or the cathode active material.

The first or the second liquid solvents may include fluorinated monomers having unsaturation (double bonds or triple bonds that can be opened up for polymerization); e.g., fluorinated vinyl carbonates, fluorinated vinyl monomers, fluorinated esters, fluorinated vinyl esters, and fluorinated vinyl ethers). Fluorinated vinyl esters include R_{f}CO₂CH═CH₂ and Propenyl Ketones, R_{f}COCH═CHCH₃, where R_{f} is F or any F-containing functional group (e.g., CF₂— and CF₂CF₃—).

Desirable sulfones as a first or second liquid solvent include, but not limited to, alkyl and aryl vinyl sulfones or sulfides; e.g., ethyl vinyl sulfide, allyl methyl sulfide, phenyl vinyl sulfide, phenyl vinyl sulfoxide, ethyl vinyl sulfone, allyl phenyl sulfone, allyl methyl sulfone, and divinyl sulfone:

Simple alkyl vinyl sulfones, such as ethyl vinyl sulfone, may be polymerized via emulsion and bulk methods. Propyl vinyl sulfone may be polymerized by alkaline persulfate initiators to form soft polymers. It may be noted that aryl vinyl sulfone, e.g., naphthyl vinyl sulfone, phenyl vinyl sulfone, and parra-substituted phenyl vinyl sulfone (R=NH₂, NO₂ or Br), were reported to be unpolymerizable with free-radical initiators. However, we have observed that phenyl and methyl vinyl sulfones can be polymerized with several anionic-type initiators. Effective anionic-type catalysts or initiators are n-BuLi, ZnEt2, LiN(CH₂)₂, NaNH₂, and complexes of n-LiBu with ZnEt2 or AlEh. A second solvent, such as pyridine, sulfolane, toluene or benzene, can be used to dissolve alkyl vinyl sulfones, aryl vinyl sulfones, and other larger sulfone molecules.

Poly(sulfone)s have high oxygen indices and low smoke emission on burning. Poly(sulfone)s are inherently self-extinguishing materials owing to their highly aromatic character. In certain embodiments, the sulfone as a first or the second liquid solvent is selected from TrMS, MTrMS, TMS, or vinyl or double bond-containing variants of TrMS, MTrMS, TMS, EMS, MMES, EMES, EMEES, or a combination thereof. The cyclic structure, such as TrMS, MTrMS, and TMS, can be polymerized via ring-opening polymerization with the assistance of an ionic type initiator.

The first or the second liquid solvent may be a nitrile preferably selected from dinitriles, such as AND, GLN, SEN and SN.

In some embodiments, the phosphate, phosphonate, phosphazene, phosphite, or sulfate, as a first liquid solvent or in the second liquid solvent, is selected from tris(trimethylsilyl) phosphite (TTSPi), alkyl phosphate, triallyl phosphate (TAP), ethylene sulfate (DTD), a combination thereof.

The phosphate, alkyl phosphonate, phosphonic acid, and phosphazene are flame-resistant. Good examples include diethyl vinylphosphonate, dimethyl vinylphosphonate, vinylphosphonic acid, diethyl allyl phosphate, and diethyl allylphosphonate:

The siloxane or silane in the second liquid solvent may be selected from alkylsiloxane (Si—O), alkyylsilane (Si—C), liquid oligomeric silaxane (—Si—O—Si—), or a combination thereof.

The reactive additive may further comprise an amide group selected from N,N-dimethylacetamide, N,N-diethylacetamide, N,N-dimethylformamide, N,N-diethylformamide, or a combination thereof.

In certain embodiments, the crosslinking agent comprises a compound having at least one reactive group selected from a hydroxyl group, an amino group, an imino group, an amide group, an acrylic amide group, an amine group, an acrylic group, an acrylic ester group, or a mercapto group in the molecule.

In certain embodiments, the crosslinking agent is selected from poly(diethanol) diacrylate, poly(ethyleneglycol)dimethacrylate, poly(diethanol) dimethylacrylate, poly(ethylene glycol) diacrylate, lithium hexafluorophosphate (LiPF₆), lithium borofluoride (LiBF₄), lithium hexafluoroarsenide (LiAsF₆), lithium trifluoro-metasulfonate (LiCF₃SO₃), bis-trifluoromethyl sulfonylimide lithium (LiN(CF₃SO₂)₂), lithium bis(oxalato)borate (LiBOB), lithium oxalyldifluoroborate (LiBF₂C₂O₄), lithium oxalyldifluoroborate (LiBF₂C₂O₄), or a combination thereof.

The initiator may be selected from an azo compound (e.g., azodiisobutyronitrile, AIBN), azobisisobutyronitrile, azobisisoheptonitrile, dimethyl azobisisobutyrate, benzoyl peroxide tert-butyl peroxide and methyl ethyl ketone peroxide, benzoyl peroxide (BPO), bis(4-tert-butylcyclohexyl)peroxydicarbonate, t-amyl peroxypivalate, 2,2′-azobis-(2,4-dimethylvaleronitrile), 2,2′-azobis-(2-methylbutyronitrile), 1,1-azobis(cyclohexane-1-carbonitrile, benzoylperoxide (BPO), hydrogen peroxide, dodecamoyl peroxide, isobutyryl peroxide, cumene hydroperoxide, tert-butyl peroxypivalate, diisopropyl peroxydicarbonate, or a combination thereof.

In the disclosed polymer electrolyte, the lithium salt may be selected from lithium perchlorate (LiClO₄), lithium hexafluorophosphate (LiPF₆), lithium borofluoride (LiBF₄), lithium hexafluoroarsenide (LiAsF₆), lithium trifluoro-metasulfonate (LiCF₃SO₃), bis-trifluoromethyl sulfonylimide lithium (LiN(CF₃SO₂)₂), lithium bis(oxalato)borate (LiBOB), lithium oxalyldifluoroborate (LiBF₂C₂O₄), lithium oxalyldifluoroborate (LiBF₂C₂O₄), lithium nitrate (LiNO₃), Li-Fluoroalkyl-Phosphates (LiPF₃(CF₂CF₃)₃), lithium bisperfluoro-ethysulfonylimide (LiBETI), lithium bis(trifluoromethanesulphonyl)imide, lithium bis(fluorosulphonyl)imide, lithium trifluoromethanesulfonimide (LiTFSI), an ionic liquid lithium salt, or a combination thereof.

The positive electrode (cathode) in the disclosed lithium cell typically comprises particles of a cathode active material and the electrolyte permeates into the cathode to come in physical contact with substantially all the cathode active material particles.

In some preferred embodiments, the battery cell contains substantially no liquid solvent left therein (substantially >99% of the liquid solvent being removed or polymerized to become a polymer). However, it is essential to initially include a liquid solvent in the cell, enabling the lithium salt to get dissociated into lithium ions and anions. A majority (>50%, preferably >70%) or substantially all of the liquid solvents is then vaporized or cured (polymerized or crosslinked). With less than 1% liquid solvent, the resulting electrolyte is a solid-state electrolyte. With less than 30% liquid solvent, we have a quasi-solid electrolyte. Both are highly flame-resistant.

A lower proportion of the liquid solvent in the electrolyte leads to a significantly reduced vapor pressure and increased flash point or completely eliminated flash point (un-detectable). Although typically by reducing the liquid solvent proportion one tends to observe a reduced lithium ion conductivity for the resulting electrolyte; however, quite surprisingly, after a threshold liquid solvent fraction, this trend is diminished or reversed (the lithium ion conductivity can actually increase with reduced liquid solvent in some cases).

The crosslinking agent preferably comprises a compound having at least one reactive group selected from a hydroxyl group, an amino group, an imino group, an amide group, an amine group, an acrylic group, or a mercapto group in the molecule.

In some embodiments, the crosslinking agent may be selected from N,N-methylene bisacrylamide, epichlorohydrin, 1,4-butanediol diglycidyl ether, tetrabutylammonium hydroxide, cinnamic acid, ferric chloride, aluminum sulfate octadecahydrate, diepoxy, dicarboxylic acid compound, poly(potassium 1-hydroxy acrylate) (PKHA), glycerol diglycidyl ether (GDE), ethylene glycol, polyethylene glycol, polyethylene glycol diglycidyl ether (PEGDE), citric acid, acrylic acid, methacrylic acid, a derivative compound of acrylic acid, a derivative compound of methacrylic acid, glycidyl functions, N,N′-Methylenebisacrylamide (MBAAm), Ethylene glycol dimethacrylate (EGDMAAm), isobornyl methacrylate, poly (acrylic acid) (PAA), methyl methacrylate, isobornyl acrylate, ethyl methacrylate, isobutyl methacrylate, n-Butyl methacrylate, ethyl acrylate, 2-Ethyl hexyl acrylate, n-Butyl acrylate, a diisocyanate, an urethane chain, a chemical derivative thereof, or a combination thereof.

In certain desirable embodiments, in both the positive and the negative electrodes, the electrolyte further comprises particles of an inorganic solid electrolyte material having a particle size from 2 nm to 30 μm, wherein the particles of inorganic solid electrolyte material are dispersed in the polymer or chemically bonded by the polymer. The particles of inorganic solid electrolyte material are preferably selected from an oxide type, sulfide type, hydride type, halide type, borate type, phosphate type, lithium phosphorus oxynitride (LiPON), garnet-type, lithium superionic conductor (LISICON) type, sodium superionic conductor (NASICON) type, or a combination thereof.

Preferably, in the bipolar lithium battery, the separator comprises the quasi-solid or solid-state electrolyte.

The bipolar lithium cell may be a lithium metal secondary battery (initially having a lithium metal layer or without a lithium metal layer when the battery is made), a lithium-ion battery, a lithium-sulfur battery, a lithium-ion sulfur battery, a lithium-selenium battery, or a lithium-air battery. A preferred embodiment of the present invention is a rechargeable lithium-sulfur battery or lithium-ion sulfur battery containing a sulfur cathode having sulfur or lithium polysulfide as a cathode active material.

The liquid solvent (containing a polymer dissolved therein) or the reactive electrolyte composition (reactive additive) is designed to permeate into the internal structure of the cathode and to be in physical contact or ionic contact with the cathode active material in the cathode, and to permeate into the anode electrode to be in physical contact or ionic contact with the anode active material where/if present.

For a lithium metal battery (wherein lithium metal is the primary active anode material), the current collector may comprise a metal foil (e.g., Al foil, Cu foal, stainless steel cell) having two primary surfaces wherein at least one primary surface is coated with a layer of graphene, or expanded graphite. One coated primary surface (the anode side) may be further coated with or protected by a layer of lithiophilic metal (a metal capable of forming a metal-Li solid solution or is wettable by lithium ions), a layer of graphene material, or both. The lithiophilic metal is preferably selected from Au, Ag, Mg, Zn, Ti, K, Al, Fe, Mn, Co, Ni, Sn, V, Cr, an alloy thereof, or a combination thereof.

For a lithium ion battery pack, there is no particular restriction on the selection of an anode active material. The anode active material may be selected from the group consisting of: (a) silicon (Si), germanium (Ge), tin (Sn), lead (Pb), antimony (Sb), phosphorus (P), bismuth (Bi), zinc (Zn), aluminum (Al), titanium (Ti), nickel (Ni), cobalt (Co), and cadmium (Cd); (b) alloys or intermetallic compounds of Si, Ge, Sn, Pb, Sb, Bi, Zn, Al, Ti, Ni, Co, or Cd with other elements; (c) oxides, carbides, nitrides, sulfides, phosphides, selenides, and tellurides of Si, Ge, Sn, Pb, Sb, Bi, Zn, Al, Ti, Fe, Ni, Co, V, or Cd, and their mixtures, composites, or lithium-containing composites; (d) salts and hydroxides of Sn; (e) lithium titanate, lithium manganate, lithium aluminate, lithium titanium niobate, lithium-containing titanium oxide, lithium transition metal oxide, ZnCo₂O₄; (f) carbon or graphite particles (g) prelithiated versions thereof; and (h) combinations thereof.

In some embodiments, the anode active material contains a prelithiated Si, prelithiated Ge, prelithiated Sn, prelithiated SnOₓ, prelithiated SiOₓ, prelithiated iron oxide, prelithiated V₂O₅, prelithiated V₃O₈, prelithiated Co₃O₄, prelithiated Ni₃O₄, or a combination thereof, wherein x=1 to 2.

The separator may comprise a polymer, inorganic, or composite solid electrolyte; it may simply comprise a porous polymer membrane. In certain embodiments, the separator comprises polymeric fibers, ceramic fibers, glass fibers, or a combination thereof. These fibers may be stacked together in such a manner that there are pores that allow for permeation of lithium ions, but not for penetration of any potentially formed lithium dendrites. These fibers may be dispersed in a matrix material or bonded by a binder material. This matrix or binder material may contain a ceramic or glass material. The polymer electrolyte herein disclosed may serve as the matrix material or binder material that helps to hold these fibers together. The separator may contain particles of a glass or ceramic material (e.g., metal oxide, metal carbide, metal nitride, metal boride, etc.).

The present disclosure also provides a method of producing the bipolar battery pack. In certain embodiments, the method comprises:
a) Providing a first set of multiple bipolar electrodes and at least one layer or multiple layers of ion-permeable separator or solid-state electrolyte, wherein at least one of the bipolar electrodes is prepared by: (A) providing a current collector comprising a conductive material foil having a thickness from 10 nm to 100 μm and two opposing primary surfaces; (B) depositing a positive electrode layer on a first primary surface, wherein the positive electrode layer comprises a mixture of particles of a cathode active material, an optional conductive additive, an optional binder resin, particles of a solid inorganic solid-state electrolyte, and a first polymer electrolyte; and (C) providing either (i) a negative electrode layer deposited on the opposing (second) primary surface wherein the negative electrode layer comprises a lithium metal layer or a layer of a mixture of particles of an anode active material, an optional conductive additive, an optional binder resin, optional particles of a solid inorganic solid-state electrolyte, and a second polymer electrolyte or (ii) initially no negative electrode layer deposited on said opposing primary surface (for the purpose of forming an anodeless lithium metal battery);
b) Stacking the multiple bipolar electrodes sequentially with the layers of ion-permeable separator or solid-state electrolyte to connect multiple bipolar electrodes in series to form a module in such a manner that a layer of ion-permeable separator or solid-state electrolyte is disposed between the negative electrode layer of a bipolar electrode and the positive electrode layer of a neighboring bipolar electrode; and
c) Optionally encasing the module with a protective housing element to form a pack.

In certain embodiments, step b) further comprises forming at least another module in a similar manner and connecting the resulting multiple modules in parallel, and step c) comprises encasing the parallel-connected multiple modules with a protective housing element to form a pack.

The positive electrode layer in step a) may be produced by (i) mixing and dispersing particles of a cathode active material, particles of a solid inorganic solid-state electrolyte, an optional resin binder, and an optional conductive additive in a liquid medium to form a liquid slurry; (ii) depositing a layer of slurry on the first primary surface of the current collector, (iii) removing the liquid medium from the slurry layer to obtain a porous positive electrode layer containing from 1% to 50% by volume of pores; (iv) preparing a first polymer solution comprising a polymer and a lithium salt dissolved in a first liquid solvent having a polymer-to-lithium salt weight ratio of from 1/100 to 100/1, wherein the polymer has a lithium-ion conductivity no less than 10⁻⁸ S/cm; and (v) impregnating the polymer solution into pores of the porous positive electrode layers and partially or totally removing the first liquid solvent from the positive electrode layer to obtain the bipolar electrode. In this procedure, steps (i)-(iii) is similar to the conventional slurry coating process for producing a cathode (positive electrode) of a lithium-ion cell. However, steps (iv) and (v) are totally new and distinct from the remaining procedures of the conventional lithium ion cell production process.

Alternatively, the positive electrode layer in step a) may be produced by (i) mixing, dispersing, or dissolving particles of a cathode active material, particles of a solid inorganic solid-state electrolyte, an optional resin binder, an optional conductive additive, and a first electrolyte polymer in a first liquid solvent to form a liquid slurry, wherein the first electrolyte polymer has a lithium-ion conductivity no less than 10⁻⁸ S/cm; (ii) depositing a layer of slurry on the first primary surface of the current collector, and (iii) partially or completely removing the first liquid solvent from the slurry layer to obtain the positive electrode layer.

In some embodiments, the negative electrode (anode) layer in step a) is produced by (i) mixing and dispersing particles of an anode active material, optional particles of a solid inorganic solid-state electrolyte, an optional resin binder, and an optional conductive additive in a liquid medium to form a liquid slurry; (ii) depositing a layer of slurry on a second primary surface of the current collector, (iii) removing the liquid medium from the slurry layer to obtain the negative electrode layer containing from 1% to 50% by volume of pores; and (iv) impregnating the pores with a polymer electrolyte. Step (iv) may be accomplished by preparing a second polymer solution comprising a second polymer and a lithium salt dissolved in a second liquid solvent (the same as or different than the first liquid solvent) having a polymer-to-lithium salt weight ratio of from 1/100 to 100/1, wherein the second polymer (the same as or different than the first polymer) has a lithium-ion conductivity no less than 10⁻⁸ S/cm; and (v) impregnating the second polymer solution into pores of the porous positive electrode layers and partially or totally removing the second liquid solvent from the negative electrode layer to obtain the bipolar electrode.

Alternatively, the negative electrode layer in step a) may be produced by (i) mixing, dispersing, or dissolving particles of an anode active material, optional particles of a solid inorganic solid-state electrolyte, an optional resin binder, an optional conductive additive, and a electrolyte polymer in a liquid solvent to form a liquid slurry; (ii) depositing a layer of slurry on the opposing primary surface of the current collector; and (iii) partially or completely removing the liquid solvent from the slurry layer to obtain the negative electrode layer.

In some embodiments, the negative electrode layer in step a) is produced by (i) depositing a reactive anode layer onto a second primary surface of the current collector to form a reactive anode layer-coated current collector, wherein the reactive anode layer comprises a mixture of multiple particles of an anode active material, an optional conductive additive, and a reactive liquid electrolyte composition comprising at least a polymerizable first liquid solvent, a lithium salt dissolved in the first liquid solvent, and a crosslinking agent and/or an initiator, wherein the first liquid solvent occupies from 1% to 99% by weight based on the total weight of the reactive liquid electrolyte composition; and (ii) partially or totally polymerizing the first liquid solvent to obtain an anode active layer coated on the current collector wherein from 30% to 100% by weight of the polymerizable first liquid solvent is polymerized to become a quasi-solid or solid-state electrolyte that chemically bonds the multiple particles of the anode active material and the conductive additive together to form an anode active layer that adheres to the second primary surface.

The first polymerizable liquid solvent may be selected from the group consisting of vinylene carbonate, ethylene carbonate, fluoroethylene carbonate, vinyl sulfite, vinyl ethylene sulfite, vinyl ethylene carbonate, 1,3-propyl sultone, 1,3-acrylic-sultones, methyl ethylene sulfone, methyl vinyl sulfone, ethyl vinyl sulfone, methyl methacrylate, vinyl acetate, acrylamide, 1,3-dioxolane (DOL), fluorinated ethers, fluorinated esters, sulfones, sulfides, nitriles, sulfates, siloxanes, silanes, phosphates, phosphonates, phosphinates, phosphines, phosphine oxides, phosphonic acids, phosphorous acid, phosphites, phosphoric acids, phosphazene compounds, derivatives thereof, and combinations thereof.

In some preferred embodiments, the process associated with the method (step (a), for instance) is conducted in a roll-to-roll manner to produce a roll of bipolar electrode. One can then un-wind the roll, cut and trim into a desired number of bipolar electrodes of desired dimensions. Alternatively, one can produce one or multiple bipolar electrodes of desired dimensions at a time using a machine system. Slurry coating, casting or spraying and drying machines are well-known in the art.

The disclosure further provides a method of producing the disclosed bipolar battery pack, the method comprising:
(a) Providing a first set of multiple bipolar electrodes and at least one layer or multiple layers of ion-permeable separator or solid-state electrolyte, wherein at least one of the bipolar electrodes is prepared by: (A) providing a first current collector comprising a first conductive material foil having a thickness from 10 nm to 100 μm and two opposing primary surfaces, herein after referred to as the first primary surface and the second primary surface, respectively; (B) depositing a positive electrode layer on the first primary surface to form a first half of the bipolar electrode, wherein the positive electrode layer comprises a mixture of particles of a cathode active material, an optional conductive additive, an optional binder resin, particles of a solid inorganic solid-state electrolyte, and a first polymer electrolyte and wherein the second surface is not deposited with a positive electrode layer or negative layer, and (C) providing a second current collector comprising a second conductive material foil, different than the first conductive material, having a thickness from 10 nm to 100 μm and two opposing primary surfaces, herein after referred to as the third primary surface and the fourth primary surface, respectively; and (D) either depositing a negative electrode layer on the third primary surface or initially having no negative electrode layer deposited on the third primary surface to obtain a second half of the bipolar electrode, wherein the negative electrode layer comprises (i) a lithium metal layer and/or (ii) a layer of a mixture of particles of an anode active material, an optional conductive additive, an optional binder resin, optional particles of a solid inorganic solid-state electrolyte, and a second polymer electrolyte, and wherein the fourth surface is not deposited with a positive electrode layer or negative electrode layer, and (E) combining the first half of the bipolar electrode and the second half of the bipolar electrode to form said bipolar electrode wherein the second primary surface are the fourth primary surface are mechanically compressed or chemically bonded together (e.g., through an adhesive);
(b) Stacking the multiple bipolar electrodes sequentially with said layers of ion-permeable separator or solid-state electrolyte to connect multiple bipolar electrodes in series to form a module in such a manner that a layer of ion-permeable separator or solid-state electrolyte is disposed between the negative electrode layer of a bipolar electrode and the positive electrode layer of a neighboring bipolar electrode; and
(c) Optionally encasing the module with a housing element to form a pack.

In some embodiments, step (b) further comprises forming at least another module in a similar manner and connecting the resulting multiple modules in parallel, and step c) comprises encasing the parallel-connected multiple modules with a protective housing element to form a pack.

These and other advantages and features of the present invention will become more transparent with the description of the following best mode practice and illustrative examples.

### BRIEF DESCRIPTION OF THE DRAWINGS

FIG. 1 Schematic of a bipolar lithium-ion battery according to some embodiments of the present disclosure.

FIG. 2(A) Schematic of a module (super-cell) comprising multiple bipolar electrodes internally connected in series according to some embodiments of the present disclosure;

FIG. 2(B) Schematic of a bipolar battery pack comprising a plurality of modules (each comprising internally series-connected bipolar electrodes); these modules are internally connected in parallel to form a pack according to some embodiments of the present disclosure;

FIG. 2(C) Schematic of a bipolar battery pack comprising a plurality of modules, internally connected in parallel and enclosed in a protective housing according to some embodiments of the present disclosure.

FIG. 3(A) Structure of a bipolar anode-less lithium metal battery (as manufactured or in a discharged state) according to some embodiments of the present disclosure;

FIG. 3(B) Structure of a bipolar anode-less lithium metal battery (in a charged state) according to some embodiments of the present disclosure.

FIG. 4(A) Schematic of a process for producing a bipolar electrode comprising a cathode layer deposited on a primary surface of a bipolar current collector and an anode layer deposited on the opposing primary surface of this current collector (or initially no anode layer is deposited) according to some embodiments of instant disclosure (removal of a liquid medium to form a solid polymer electrolyte in the cathode);

FIG. 4(B) Schematic of another process for producing a bipolar electrode comprising a cathode layer deposited on a primary surface of a bipolar current collector and an anode layer deposited on the opposing primary surface of this current collector (or initially no anode layer is deposited) according to some embodiments of instant disclosure (filling pores in the cathode with a polymer solution, followed by removing liquid electrolyte from the polymer solution);

FIG. 4(C) Schematic of a process for producing a bipolar electrode comprising a cathode layer deposited on a primary surface of a bipolar current collector (e.g., using process described in FIG. 4(A) or 4(B)) and an anode layer deposited on the opposing primary surface of this current collector according to some embodiments of instant disclosure (polymerization and/or crosslinking of a polymerizable liquid solvent in the anode);

FIG. 4(D) Schematic of a process for producing a bipolar electrode comprising a cathode layer deposited on a primary surface of a bipolar current collector (e.g., using process described in FIG. 4(A) or 4(B)) and an anode layer deposited on the opposing primary surface of this current collector according to some embodiments of instant disclosure (polymerization and/or crosslinking of a polymerizable liquid solvent in the pores of a porous anode).

FIG. 5 Schematic of a process to produce a roll of bipolar electrode in a roll-to-roll or reel-to-reel manner according to some embodiments of the present disclosure.

### DETAILED DESCRIPTION

The present invention provides a safe and high-performing lithium battery, which can be any of various types of lithium-ion or lithium metal batteries. A high degree of safety is imparted to this battery by a novel and unique electrolyte that is highly flame-resistant and would not initiate a fire or sustain a fire and, hence, would not pose explosion danger. This invention has solved the very most critical issue that has plagued the lithium-metal and lithium-ion industries for more than two decades. As indicated earlier in the Background section, a strong need exists for a safe, non-flammable quasi-solid electrolyte or solid-state electrolyte system for a rechargeable lithium battery, particularly a bipolar lithium battery system.

The present disclosure provides a bipolar battery pack comprising one or a plurality of modules wherein at least one module comprises a first set of multiple bipolar electrodes internally connected in series, wherein at least one of the bipolar electrodes comprises:
A) A current collector comprising a conductive material foil having a thickness from 10 nm to 100 μm and two opposing primary surfaces;
B) a positive electrode (cathode) layer disposed on one of the two primary surfaces (also herein referred to as a first primary surface), wherein the positive electrode layer comprises a mixture of particles of a cathode active material, an optional but typically desired conductive additive, an optional binder resin, and a first hybrid electrolyte comprising a mixture of an inorganic solid-state electrolyte and a solid polymer electrolyte or gel polymer electrolyte, wherein the solid polymer or gel polymer electrolyte comprises a polymer, having a lithium ion conductivity no less than 1.0×10⁻⁸ S/cm, which is a product prepared by partially or totally removing a first solvent from a polymer solution originally comprising a polymer and a lithium salt dissolved in the first solvent having a polymer-to-lithium salt weight ratio of from 1/100 to 100/1; and
C) either (i) a negative electrode layer deposited on the opposing primary surface (also herein referred to as the second primary surface) wherein the negative electrode layer comprises a lithium metal layer or a mixture of particles of an anode active material, a solid polymer electrolyte or gel polymer electrolyte, and, optionally, particles of a solid inorganic solid-state electrolyte wherein the solid or gel polymer comprises a lithium salt dispersed therein with a polymer-to-lithium salt weight ratio of from 1/100 to 100/1 or (ii) initially without a negative electrode layer deposited on said opposing primary surface (so-called “anodeless”) when the battery pack is made (a lithium metal layer is formed when the battery pack is charged);
   wherein the multiple bipolar electrodes are connected in series in such a manner that an ion-permeable separator or solid-state electrolyte layer is disposed between the negative electrode layer of a bipolar electrode and the positive electrode layer of a neighboring bipolar electrode and in close contact with this negative electrode layer and this positive electrode layer.

The bipolar battery pack may comprise multiple sets (modules) of multiple bipolar electrodes internally connected in series and these multiple sets (modules) of multiple bipolar electrodes are internally connected in parallel. Preferably, the bipolar battery pack further comprises a protecting housing that encloses the multiple modules.

In some preferred embodiments, the solid polymer or gel polymer electrolyte and the inorganic solid-state electrolyte, in combination, form a contiguous phase in the cathode, in the anode, or in both the anode and the cathode, and the contiguous phase is in a physical contact or ionic communication with the ion-permeable separator or solid-state electrolyte layer. This would ensure uninterrupted flow of lithium ions from the cathode, through the separator (or solid-state electrolyte), into the anode during the battery charge, as well as flow from the anode through the separator and into the cathode (throughout the entire cathode).

The current collector may comprise a metal foil (e.g., Al foil, Cu foil, stainless steel cell, etc.), a conducting polymer or polymer composite layer, a graphite layer (expanded graphite or recompressed graphite worm) layer, or graphene layer. The current collector has two primary surfaces wherein preferably at least one primary surface is coated with a protective layer of graphene or expanded graphite to prevent lithium diffusion in the metal foil, which otherwise could defeat the purpose of a bipolar electrode. This protective graphene/graphite coating layer mat contain just the graphene, expanded graphite flakes, and/or recompressed exfoliated graphite worms or a composite layer comprising graphene sheets, expanded graphite flakes, and/or recompressed exfoliated graphite worms that are dispersed in or bonded by a matrix or binder material. The bonder/matrix material may be selected from a polymer, glass, ceramic, or carbon material.

Alternatively, this conductive foil contains a laminate of two or more conductive materials laminated together. For instance, this can contain a layer of Cu (for supporting the negative electrode layer) and a layer of Al (for supporting the positive electrode layer) that are mechanically compressed or chemically bonded together. This can also be a Cu foil or Al foil coated with a layer of conductive polymer (e.g., an intrinsically conductive polymer or a polymer matrix containing conductive fillers dispersed therein; examples of conductive fillers being graphene sheets, carbon nanotubes, carbon fibers, carbon black particles, etc.).

In the bipolar pack, the solid polymer electrolyte or gel polymer electrolyte preferably comprises a polymer selected from poly(ethylene oxide), polypropylene oxide, polyoxymethylene, polyvinylene carbonate, polypropylene carbonate, poly(ethylene glycol), poly(acrylonitrile), poly(methyl methacrylate), poly(vinylidene fluoride), poly bis-methoxy ethoxyethoxide-phosphazenex, polyvinyl chloride, polydimethylsiloxane, poly(vinylidene fluoride)-hexafluoropropylene, cyanoethyl poly(vinyl alcohol), a pentaerythritol tetra-acrylate-based polymer, an aliphatic polycarbonate, a single Li-ion conducting solid polymer, poly(ethylene glycol) diacrylate, poly(ethylene glycol) methyl ether acrylate, polyurethane, polyurethane-urea, polyacrylamide, a polyionic liquid, polymerized 1,3-dioxolane, polyepoxide ether, polysiloxane, poly(acrylonitrile-butadiene), polynorbornene, poly(hydroxyl styrene), poly(ether ether ketone), polypeptoid, poly(ethylene-maleic anhydride), polycaprolactone, poly(trimethylene carbonate), polyphosphate, polyphosphonate, polyphosphinate, polyphosphine, polyphosphine oxide, a polymer synthesized from an ionic liquid, a copolymer thereof, a semi-penetrating network thereof, a sulfonated derivative thereof, or a combination thereof.

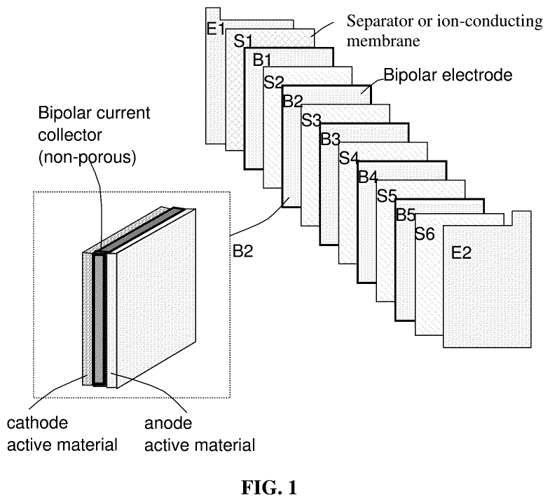

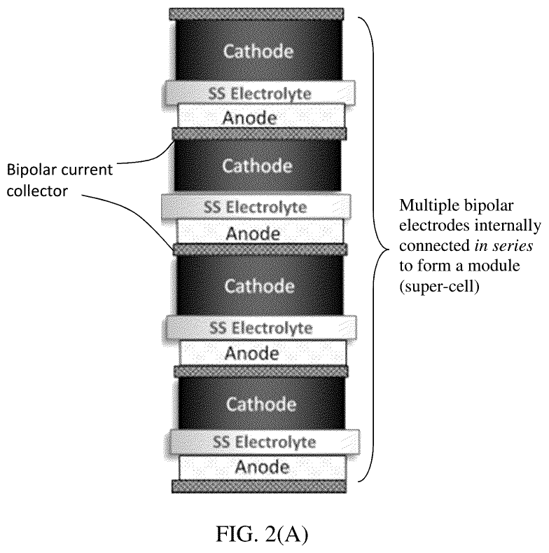

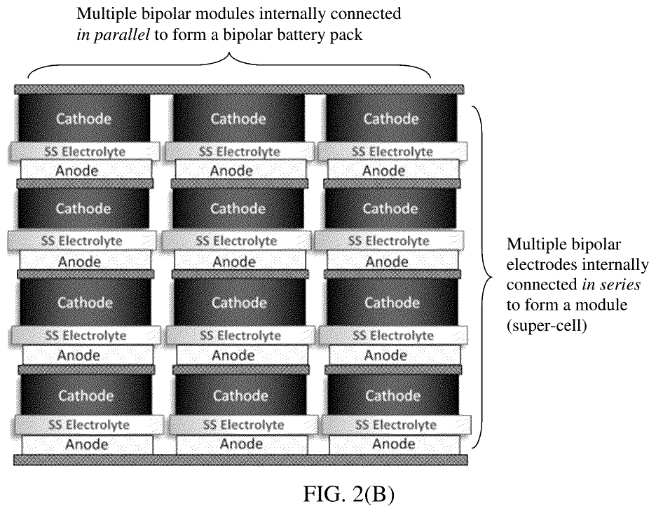

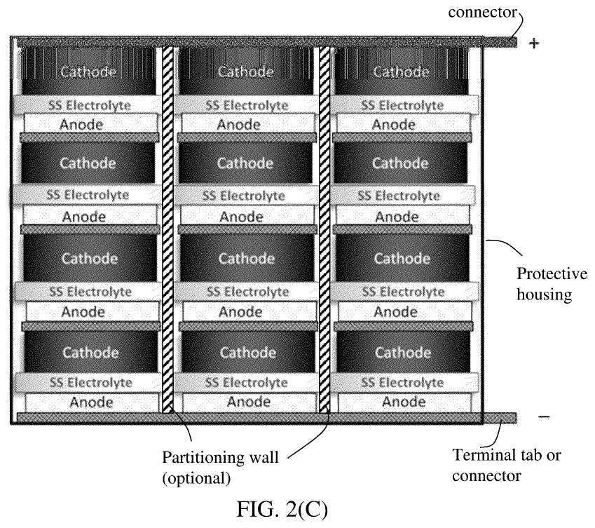

The bipolar battery pack may comprise a module or a plurality of module wherein each module is a stack of multiple bipolar electrodes separated by a lithium-ion permeable membrane (separator, or a solid-state electrolyte) between two bipolar electrodes that are internally connected in series. The resulting module comprises multiple unit cells, each cell comprising an anode layer (coated on a bipolar current collector), a separator, and a cathode layer (coated on neighboring current collector). As illustrated in FIG. 1 as one example, the internal series connection (ISC) technology involves combining a desired number of bipolar electrodes (e.g., B1-B5), separated from one another by an ion-permeable separator (e.g., S1-S6), and cladded by two terminal electrodes (E1 and E2). In this configuration, only these two terminal electrodes are externally connected to the outside circuit and all the intermediate bipolar electrodes are isolated from the outside circuit. Series connection provides a high voltage output (high V), which is the sum of the voltage values of all cells: for instance, if one cell giving 3.7 volts (e.g., for a graphite-LiCo₂ cell), then two cells giving 7.4 volts, and n cells giving 3.7n volts, etc. The number n can be any integer that is 2 or greater than 2 (for practical purposes, n is from 2 to 1,000). This is further illustrated in FIG. 2(A).

FIG. 1 provides but one example of the many possible combinations for high-voltage stacks. The five intermediate electrodes (B1-B5) are bipolar electrodes, each composed of a non-porous conductive metal foil having one primary surface coated with an anode active material layer and the opposing primary surface coated with a cathode active material layer. The separator S1 is inserted between terminal electrode E1 and the first bipolar electrode B1 and the separator S2 is inserted between bipolar electrode B1 and bipolar electrode B2, etc. Such a configuration implies that each separator is sandwiched between an anode layer of a bipolar electrode and a cathode layer of a neighboring bipolar electrode to form a unit cell. For instance, S2 is sandwiched between the anode layer coated on B1 and the cathode layer coated on B2 to form a unit cell, and S3 is sandwiched between the anode layer coated on B2 and the cathode layer coated on B3 to form another unit cell. These two unit cells are naturally connected in-series through the metal foil at B2, without using an external wire and terminal and, thereby, reducing the weight, volume, and electrical resistance of a lithium battery stack.

During a charging step, lithium ions come out of the cathode active material layer and travels through a separator into an anode active material layer, which belongs to the same unit cell but supported by a different bipolar current collector. During a subsequent discharge step, lithium ions travel in the opposite direction. These lithium ions are confined in a unit cell, and not to be allowed to stray into a neighboring cell. This condition can be met if the electrolyte is a solid-state electrolyte and the current collector is made out of an electrically conductive material that is not permeable to lithium ions. The graphene or expanded graphite (or exfoliated graphite worm) coating makes the metal foil non-permeable to lithium ions.

The number of unit cells in a stack depends upon the needed output voltage of the stack. Using a unit cell voltage of 3.7 volts as a basis, a lithium-ion battery stack for use in an electric power scooter (48V), for instance, will require 13 unit cells connected in series. Such a stack constitutes a lithium-ion battery “element” which, if inserted into a casing and fitted with a PC board (control electronics), makes a great power module.

As schematically illustrated in FIG. 2(B), multiple modules, each composed of internally series-connected bipolar plates, may be internally connected in parallel to form a bipolar battery pack to increase the battery capacity (Amp-hours, or Ah). As illustrated in FIG. 2(C), the bipolar battery pack is preferably protected by a protective housing, allowing at least two terminals protruded out of the housing unit for connecting to outside circuit.

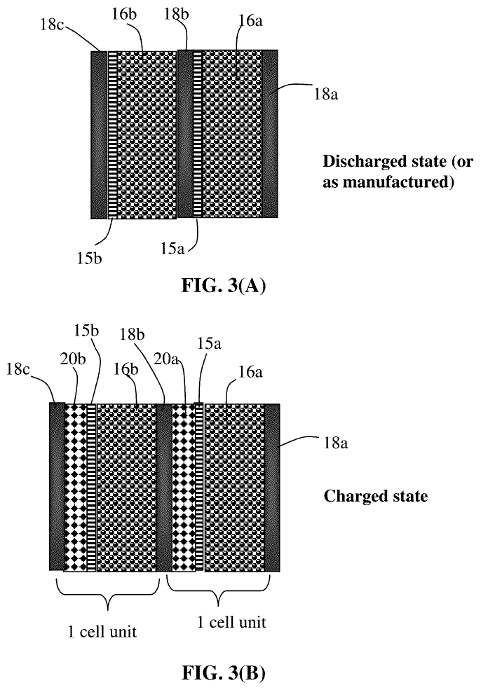

In a special battery configuration, a primary surface of the bipolar current collector is deposited with a cathode active material layer containing particles of a cathode active material (e.g., LiCoO₂, LiMn₂O₄, etc.) having available Li atoms in the structure; but the opposing primary surface is not deposited with any anode material (as schematically illustrated in FIG. 3(A)) or is deposited with a lithium metal-protecting layer only (such as an elastic polymer or a graphene ball layer) but no lithium metal or other anode active material when the bipolar electrode or the bipolar battery is made (prior to the first charge step). Such a bipolar lithium battery is herein referred to as an “anode-less” bipolar lithium metal battery. During the discharge step, lithium ions come out of the cathode material structure, traverse a separator, and move to the anode side where the lithium ions deposit onto the opposing primary surface of the current collector to form a lithium metal layer. This is illustrated in FIG. 3(B).

The presently invented internal series connection (ISC) and internal parallel connection (IPC) bipolar battery technology has the following features:

(1) The stack perimeter should be properly sealed to ensure that each and every constituent cell is isolated from one another; this is readily achievable with a solid-state electrolyte or quasi-solid electrolyte herein disclosed. In addition, none of the bipolar current collectors can be porous; they have to be absolutely impermeable to electrolyte. This is achieved by using a solid metal foil which is preferably further protected by a graphene or expanded graphite layer. The electrolyte from one unit cell is not allowed to enter another unit cell; there is no fluid communication between two cells.

(2) Any output voltage (V) and capacity value (Ah) can be tailor-made by selecting a proper number of unit cells and the lateral dimensions and thickness of the anode layer and the cathode layer of a unit cell; any practical voltage can be easily obtained. The capacity value of a pack can be increased by increasing the number of modules connected in parallel.

(3) During re-charge, each constituent cell in a multi-cell battery stack can adjust itself to attain voltage distribution equilibrium, removing the need for the high-voltage stack to have a protective circuit.

(4) The ISC and IPC technology enables significant savings in materials, volume and weight of cell-to-cell connectors and elimination of most welds necessary for the conventional modules/packs.

(5) As such, much higher energy density, higher specific energy, and higher power density can be achieved at lower costs.

(6) With multiple cells electrically connected in series naturally, one can produce a high-voltage “super-cell” having an output voltage from 6.4 volts to 800+ volts (no theoretical upper limit) with minimal connector weights, volumes, and costs.

In the conventional lithium-ion battery or lithium metal battery industry, the liquid solvents listed above are commonly used as a solvent to dissolve a lithium salt therein and the resulting solutions are used as a liquid electrolyte. These liquid solvents have a relatively high dielectric constant and, hence, are capable of dissolving a high amount of a lithium salt. However, they are typically highly volatile, having a low flash point and being highly flammable.

In the presently disclosed bipolar electrodes, the cathode (positive electrode) layer and the anode (negative electrode) layer contain substantially solid-state electrolytes produced by at least two approaches: (1) dissolving a polymer and a lithium salt in a liquid medium to obtain a liquid solution, allowing the liquid solution to permeate into an active material electrode (or well mix with other solid ingredients (e.g., particles of an active material, conductive additive, binder, and particles of an inorganic solid electrolyte) in an active material electrode, followed by removing the liquid medium, resulting in the formation of a solid-state electrolyte (e.g., polymer or polymer+inorganic solid electrolyte); and (2) dissolving a monomer or oligomer, an initiator and/or crosslinking agent, and a lithium salt in a liquid solvent (the monomer itself may be the liquid solvent) to obtain a liquid solution, allowing the liquid solution to permeate into an active material electrode (or well mix with other solid ingredients (e.g., particles of an active material, conductive additive, binder, and particles of an inorganic solid electrolyte) in an active material electrode, followed by polymerizing/crosslinking the polymerizable liquid solvent or monomer, resulting in the formation of a solid-state electrolyte.

It is highly advantageous to be able to polymerize the liquid solvent once the liquid electrolyte (having a lithium salt dissolved in the first liquid solvent) is mixed with particles of an electrode active material (cathode active material or anode active material) or injected into an electrode (cathode layer or anode layer). With such an innovative strategy, one can readily reduce the liquid solvent (leaving behind select non-flammable or flame-retardant solvent only, if so desired) or completely eliminate the volatile liquid solvent all together. A desired amount of a second liquid solvent, preferably a flame-resistant liquid solvent, may be retained in the battery cell to improve the lithium-ion conductivity of the electrolyte. Desirable flame retardant-type second liquid solvents are, as examples, alkyl phosphates, alkyl phosphonates, phosphazenes, hydrofluoroethers, fluorinated ethers, and fluorinated esters.

This strategy enables us to achieve several desirable features of the resultant electrolytes and bipolar batteries:
a) no liquid electrolyte leakage issue (the in situ cured polymer or solidified polymer being capable of holding the remaining liquid together to form a gel);
b) adequate lithium salt amount can be dissolved in the electrolyte, enabling a good lithium ion conductivity;
c) reduced or eliminated flammability (only a solid polymer/inorganic solid electrolyte and, if desired, a non-flammable second liquid are retained in the cell);
d) good ability of the electrolyte to wet on anode/cathode active material surfaces (hence, significantly reduced interfacial impedance and internal resistance);
e) processing ease and compatibility with current lithium-ion battery production processes and equipment, etc.; and
f) enabling a high cathode active material proportion in the cathode electrode (typically 75-97%, in contrast to typically less than 75% by weight of the cathode active material when working with a conventional solid polymer electrolyte or inorganic solid electrolyte.

This disclosed in situ-cured polymer and/or in situ-solidified (solvent removal) electrolyte approach is of significant utility value since most of the organic solvents are known to be volatile and flammable, posing a fire and explosion danger. Further, current solid-state electrolytes are not compatible with existing lithium-ion battery manufacturing equipment and processes.

In certain preferred embodiments, the first (or the third) or the second liquid solvent comprises a flame-resisting or flame-retardant liquid selected from an organic phosphorus compound, an inorganic phosphorus compound, a halogenated derivative thereof, or a combination thereof. The organic phosphorus compound or the inorganic phosphorus compound preferably is selected from the group consisting of phosphates, phosphonates, phosphonic acids, phosphorous acids, phosphites, phosphoric acids, phosphinates, phosphines, phosphine oxides, phosphazene compounds, derivatives thereof, and combinations thereof.

In certain embodiments, the first or the second liquid solvent is selected from the group consisting of fluorinated ethers, fluorinated esters, sulfones, sulfides, nitriles, sulfates, siloxanes, silanes, phosphates, phosphonates, phosphinates, phosphines, phosphine oxides, phosphonic acids, phosphorous acid, phosphites, phosphoric acids, phosphazene compounds, derivatives thereof, and combinations thereof.

In some embodiments, the second liquid solvent is selected from a phosphate, phosphonate, phosphinate, phosphine, or phosphine oxide having the structure of:

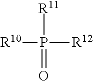

wherein R¹⁰, R¹¹, and R¹², are independently selected from the group consisting of alkyl, aryl, heteroalkyl, heteroaryl, halogen substituted alkyl, halogen substituted aryl, halogen substituted heteroalkyl, halogen substituted heteroaryl, alkoxy, aryloxy, heteroalkoxy, heteroaryloxy, halogen substituted alkoxy, halogen substituted aryloxy, halogen substituted heteroalkoxy, and halogen substituted heteroaryloxy functional groups, and the second liquid solvent is stable under an applied electrical potential no less than 4 V.

In some embodiments, the second liquid solvent comprises a phosphoranimine having the structure of:

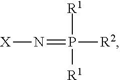

wherein R¹, R², and R³ are independently selected from the group consisting of alkyl, aryl, heteroalkyl, heteroaryl, halogen substituted alkyl, halogen substituted aryl, halogen substituted heteroalkyl, halogen substituted heteroaryl, alkoxy, aryloxy, heteroalkoxy, heteroaryloxy, halogen substituted alkoxy, halogen substituted aryloxy, halogen substituted heteroalkoxy, and halogen substituted heteroaryloxy functional groups, wherein R¹, R², and R³ are represented by at least two different substituents and wherein X is selected from the group consisting of an organosilyl group or a tert-butyl group. The R¹, R², and R³ may be each independently selected from the group consisting of an alkoxy group, and an aryloxy group.

The polymer electrolyte typically has a lithium ion conductivity from 10⁻⁸ S/cm to 10⁻² S/cm at room temperature. The cathode active layer may contain a cathode active material (along with a conductive additive and an optional resin binder). The anode may have no anode active material in the beginning when the battery is made. It may be noted that if no conventional anode active material, such as graphite, Si, SiO, Sn. or conversion-type anode materials, and no lithium metal is present in the battery when the battery is assembled and before the battery begins to charge and discharge, the battery is commonly referred to as an “anode-less” lithium battery.

It may be noted that these first liquid solvents, upon solidification or upon polymerization, become essentially non-flammable. These liquid solvents were typically known to be useful for dissolving a lithium salt and not known for their polymerizability or their potential as an electrolyte polymer.

In some preferred embodiments, the battery contains substantially no volatile liquid solvent therein after polymerization. However, it is essential to initially include a liquid solvent in the cell, enabling the lithium salt to get dissociated into lithium ions and anions. A majority (>50%, preferably >70%) or substantially all of the first liquid solvent (particularly the organic solvent) is then removed (solidified) or polymerized. With substantially 0% liquid solvent, the resulting electrolyte is a solid-state electrolyte. With less than 30% liquid solvent, we have a quasi-solid electrolyte. Both are highly flame-resistant.

A lower proportion of the unpolymerized liquid solvent in the electrolyte leads to a significantly reduced vapor pressure and increased flash point or completely eliminated flash point (un-detectable). Although typically by reducing the liquid solvent proportion one tends to observe a reduced lithium ion conductivity for the resulting electrolyte; however, quite surprisingly, after a threshold liquid solvent fraction, this trend is diminished or reversed (the lithium ion conductivity can actually increase with reduced liquid solvent in some cases).

In certain embodiments, the reactive additive comprises a first polymerizable liquid solvent and a second liquid solvent and wherein the second liquid solvent either is not polymerizable or is polymerizable but polymerized to a lesser extent as compared to the first polymerizable liquid solvent. The presence of this second liquid solvent is designed to impart certain desired properties to the polymerized electrolyte, such as lithium ion conductivity, flame retardancy, ability of the electrolyte to permeate into the electrode (anode and/or cathode) to properly wet the surfaces of the anode active material and/or the cathode active material.

In some embodiments, the first or the second liquid solvent is selected from a fluorinated carbonate, hydrofluoroether, fluorinated ester, sulfone, nitrile, phosphate, phosphite, alkyl phosphonate, phosphazene, sulfate, siloxane, silane, 1,3-dioxolane (DOL), 1,2-dimethoxyethane (DME), tetraethylene glycol dimethylether (TEGDME), poly(ethylene glycol) dimethyl ether (PEGDME), diethylene glycol dibutyl ether (DEGDBE), 2-ethoxyethyl ether (EEE), sulfone, sulfolane, ethylene carbonate (EC), dimethyl carbonate (DMC), methylethyl carbonate (MEC), diethyl carbonate (DEC), ethyl propionate, methyl propionate, propylene carbonate (PC), gamma-butyrolactone (γ-BL), acetonitrile (AN), ethyl acetate (EA), propyl formate (PF), methyl formate (MF), toluene, xylene, methyl acetate (MA), fluoroethylene carbonate (FEC), vinylene carbonate (VC), allyl ethyl carbonate (AEC), or a combination thereof.

Desirable polymerizable liquid solvents can include fluorinated monomers having unsaturation (double bonds or triple bonds) in the backbone or cyclic structure (e.g., fluorinated vinyl carbonates, fluorinated vinyl monomers, fluorinated esters, fluorinated vinyl esters, and fluorinated vinyl ethers). These chemical species may also be used as a second liquid solvent in the presently disclosed electrolyte. Fluorinated vinyl esters include R_{f}CO₂CH═CH₂ and Propenyl Ketones, R_{f}COCH═CHCH₃, where R_{f} is F or any F-containing functional group (e.g., CF₂— and CF₂CF₃—).

Two examples of fluorinated vinyl carbonates are given below:

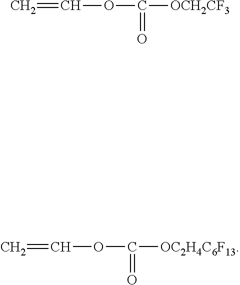

These liquid solvents, as a monomer, can be cured in the presence of an initiator (e.g., 2-Hydroxy-2-methyl-1-phenyl-propan-1-one, Ciba DAROCUR-1173, which can be activated by UV or electron beam):

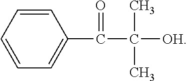

In some embodiments, the fluorinated carbonate is selected from vinyl- or double bond-containing variants of fluoroethylene carbonate (FEC), DFDMEC, FNPEC, hydrofluoro ether (HFE), trifluoro propylene carbonate (FPC), or methyl nonafluorobutyl ether (MFE), wherein the chemical formulae for FEC, DFDMEC, and FNPEC, respectively are shown below:

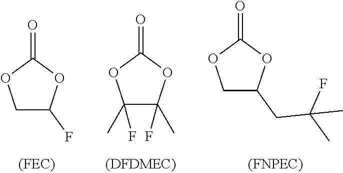

Desirable sulfones or sulfides as a polymerizable first liquid solvent or as a second liquid solvent include, but not limited to, alkyl and aryl vinyl sulfones or sulfides; e.g., ethyl vinyl sulfide, allyl methyl sulfide, phenyl vinyl sulfide, phenyl vinyl sulfoxide, ethyl vinyl sulfone, allyl phenyl sulfone, allyl methyl sulfone, and divinyl sulfone; some examples are shown below:

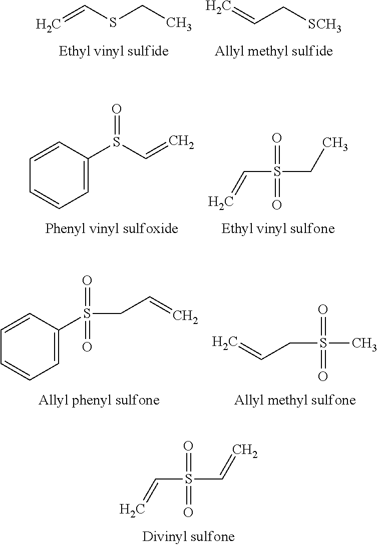

Simple alkyl vinyl sulfones, such as ethyl vinyl sulfone, may be polymerized via emulsion and bulk methods. Propyl vinyl sulfone may be polymerized by alkaline persulfate initiators to form soft polymers. It may be noted that aryl vinyl sulfone, e.g., naphthyl vinyl sulfone, phenyl vinyl sulfone, and parra-substituted phenyl vinyl sulfone (R=NH₂, NO₂ or Br), were reported to be unpolymerizable with free-radical initiators. However, we have observed that phenyl and methyl vinyl sulfones can be polymerized with several anionic-type initiators. Effective anionic-type catalysts or initiators are n-BuLi, ZnEt2, LiN(CH₂)₂, NaNH₂, and complexes of n-LiBu with ZnEt2 or AlEh. A second solvent, such as pyridine, sulfolane, toluene or benzene, can be used to dissolve alkyl vinyl sulfones, aryl vinyl sulfones, and other larger sulfone molecules.

In certain embodiments, the sulfone is selected from TrMS, MTrMS, TMS, or vinyl or double bond-containing variants of TrMS, MTrMS, TMS, EMS, MMES, EMES, EMEES, or a combination thereof; their chemical formulae being given below:

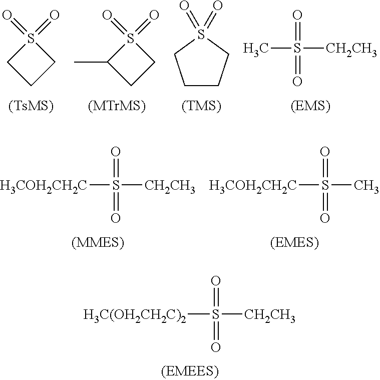

The cyclic structure, such as TrMS, MTrMS, and TMS, can be polymerized via ring-opening polymerization with the assistance of an ionic type initiator.

The nitrile may be selected from AND, GLN, SEN, SN, or a combination thereof and their chemical formulae are given below:

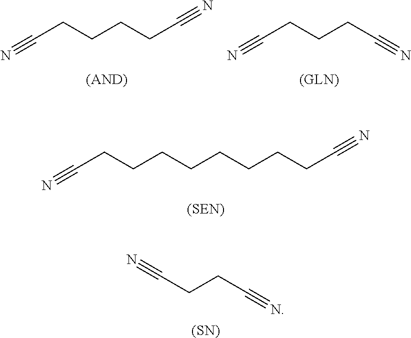

In some embodiments, the phosphate (including various derivatives of phosphoric acid), alkyl phosphonate, phosphazene, phosphite, or sulfate is selected from tris(trimethylsilyl) phosphite (TTSPi), alkyl phosphate, triallyl phosphate (TAP), ethylene sulfate (DTD), a combination thereof, or a combination with 1,3-propane sultone (PS) or propene sultone (PES). The phosphate, alkyl phosphonate, or phosphazene may be selected from the following:

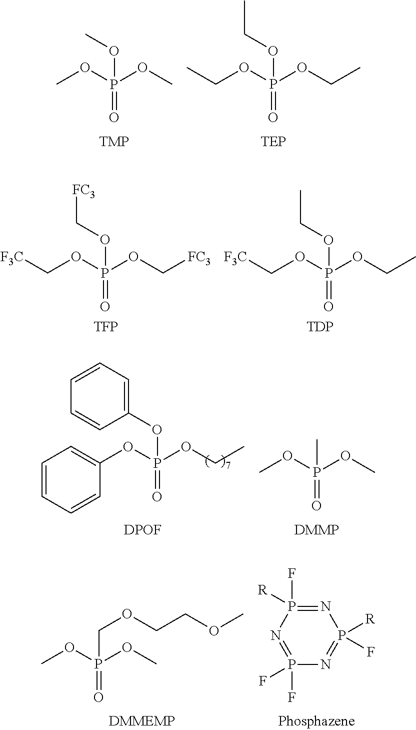

wherein R═H, NH₂, or C₁-C₆ alkyl.

Phosphonate moieties can be readily introduced into vinyl monomers to produce allyl-type, vinyl-type, styrenic-type and (meth)acrylic-type monomers bearing phosphonate groups (e.g., either mono or bisphosphonate). These liquid solvents may serve as a first or a second liquid solvent in the electrolyte composition. The phosphate, alkyl phosphonate, phosphonic acid, and phosphazene, upon polymerization, are found to be essentially non-flammable. Good examples include diethyl vinylphosphonate, dimethyl vinylphosphonate, vinylphosphonic acid, diethyl allyl phosphate, and diethyl allylphosphonate:

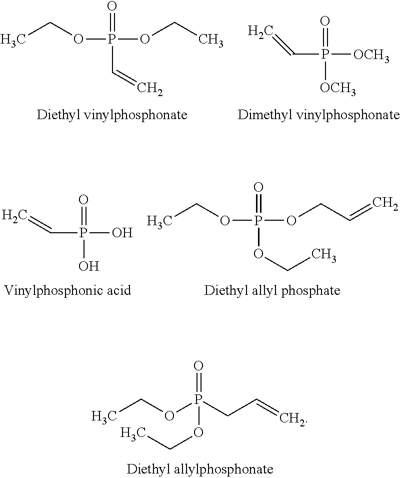

Examples of initiator compounds that can be used in the polymerization of vinylphosphonic acid are peroxides such as benzoyl peroxide, toluy peroxide, di-tert.butyl peroxide, chloro benzoyl peroxide, or hydroperoxides such as methylethyl ketone peroxide, tert. butyl hydroperoxide, cumene hydroperoxide, hydrogen Superoxide, or azo-bis-iso-butyro nitrile, or sulfinic acids such as p-methoxyphenyl-sulfinic acid, isoamyl-sulfinic acid, benzene-sulfinic acid, or combinations of various of such catalysts with one another and/or combinations for example, with formaldehyde sodium sulfoxylate or with alkali metal sulfites.

The siloxane or silane may be selected from alkylsiloxane (Si—O), alkyylsilane (Si—C), liquid oligomeric silaxane (—Si—O—Si—), or a combination thereof.

The reactive additive or reactive liquid electrolyte may further comprise an amide group selected from N,N-dimethylacetamide, N,N-diethylacetamide, N,N-dimethylformamide, N,N-diethylformamide, or a combination thereof.

In certain embodiments, the crosslinking agent comprises a compound having at least one reactive group selected from a hydroxyl group, an amino group, an imino group, an amide group, an acrylic amide group, an amine group, an acrylic group, an acrylic ester group, or a mercapto group in the molecule.

In certain embodiments, the crosslinking agent is selected from poly(diethanol) diacrylate, poly(ethyleneglycol)dimethacrylate, poly(diethanol) dimethylacrylate, poly(ethylene glycol) diacrylate, lithium hexafluorophosphate (LiPF₆), lithium borofluoride (LiBF₄), lithium hexafluoroarsenide (LiAsF₆), lithium trifluoro-metasulfonate (LiCF₃SO₃), bis-trifluoromethyl sulfonylimide lithium (LiN(CF₃SO₂)₂), lithium bis(oxalato)borate (LiBOB), lithium oxalyldifluoroborate (LiBF₂C₂O₄), lithium oxalyldifluoroborate (LiBF₂C₂O₄), or a combination thereof.

The initiator may be selected from an azo compound (e.g., azodiisobutyronitrile, AIBN), azobisisobutyronitrile, azobisisoheptonitrile, dimethyl azobisisobutyrate, benzoyl peroxide tert-butyl peroxide and methyl ethyl ketone peroxide, benzoyl peroxide (BPO), bis(4-tert-butylcyclohexyl)peroxydicarbonate, t-amyl peroxypivalate, 2,2′-azobis-(2,4-dimethylvaleronitrile), 2,2′-azobis-(2-methylbutyronitrile), 1,1-azobis(cyclohexane-1-carbonitrile, benzoylperoxide (BPO), hydrogen peroxide, dodecamoyl peroxide, isobutyryl peroxide, cumene hydroperoxide, tert-butyl peroxypivalate, diisopropyl peroxydicarbonate, or a combination thereof.

In the disclosed polymer electrolyte, the lithium salt may be selected from lithium perchlorate (LiClO₄), lithium hexafluorophosphate (LiPF₆), lithium borofluoride (LiBF₄), lithium hexafluoroarsenide (LiAsF₆), lithium trifluoro-metasulfonate (LiCF₃SO₃), bis-trifluoromethyl sulfonylimide lithium (LiN(CF₃SO₂)₂), lithium bis(oxalato)borate (LiBOB), lithium oxalyldifluoroborate (LiBF₂C₂O₄), lithium oxalyldifluoroborate (LiBF₂C₂O₄), lithium nitrate (LiNO₃), Li-Fluoroalkyl-Phosphates (LiPF₃(CF₂CF₃)₃), lithium bisperfluoro-ethysulfonylimide (LiBETI), lithium bis(trifluoromethanesulphonyl)imide, lithium bis(fluorosulphonyl)imide, lithium trifluoromethanesulfonimide (LiTFSI), an ionic liquid lithium salt, or a combination thereof.

The crosslinking agent preferably comprises a compound having at least one reactive group selected from a hydroxyl group, an amino group, an imino group, an amide group, an amine group, an acrylic group, or a mercapto group in the molecule. The amine group is preferably selected from Chemical Formula 2:

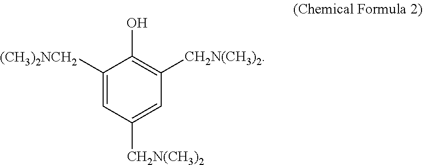

In the bipolar electrode or the bipolar lithium battery, the reactive additive may further comprise a chemical species represented by Chemical Formula 3 or a derivative thereof and the crosslinking agent comprises a chemical species represented by Chemical Formula 4 or a derivative thereof:

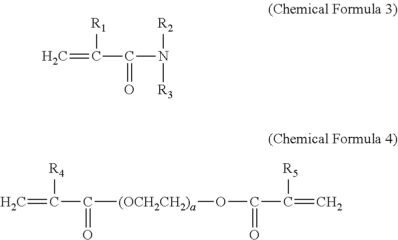

where R₁ is hydrogen or methyl group, and R₂ and R₃ are each independently one selected from the group consisting of hydrogen, methyl, ethyl, propyl, dialkylaminopropyl (—C₃ H₆ N(R′)₂) and hydroxyethyl (CH₂ CH₂ OH) groups, and R₄ and R₅ are each independently hydrogen or methyl group, and n is an integer from 3 to 30, wherein R′ is C₁-C₅ alkyl group.

Examples of suitable vinyl monomers having Chemical formula 3 include acrylamide, N,N-dimethylacrylamide, N,N-diethylacrylamide, N-isopropylacrylamide, N,N-dimethylamino-propylacrylamide, and N-acryloylmorpholine. Among these species, N-isopropylacrylamide and N-acryloylmorpholine are preferred.

The crosslinking agent is preferably selected from N,N-methylene bisacrylamide, epichlorohydrin, 1,4-butanediol diglycidyl ether, tetrabutylammonium hydroxide, cinnamic acid, ferric chloride, aluminum sulfate octadecahydrate, diepoxy, dicarboxylic acid compound, poly(potassium 1-hydroxy acrylate) (PKHA), glycerol diglycidyl ether (GDE), ethylene glycol, polyethylene glycol, polyethylene glycol diglycidyl ether (PEGDE), citric acid (Formula 4 below), acrylic acid, methacrylic acid, a derivative compound of acrylic acid, a derivative compound of methacrylic acid (e.g. polyhydroxyethylmethacrylate), glycidyl functions, N,N′-Methylenebisacrylamide (MBAAm), Ethylene glycol dimethacrylate (EGDMAAm), isobornyl methacrylate, poly (acrylic acid) (PAA), methyl methacrylate, isobornyl acrylate, ethyl methacrylate, isobutyl methacrylate, n-Butyl methacrylate, ethyl acrylate, 2-Ethyl hexyl acrylate, n-Butyl acrylate, a diisocyanate (e.g. methylene diphenyl diisocyanate. MDI), an urethane chain, a chemical derivative thereof, or a combination thereof.

The inorganic solid electrolyte material may be selected from an oxide type, sulfide type (including, but not limited to, the thio-LISICON type, glass-type, glass ceramic-type, and argyrodite-type sulfide electrolyte), hydride type, halide type, borate type, phosphate type, lithium phosphorus oxynitride (LiPON), garnet-type, lithium superionic conductor (LISICON) type, sodium superionic conductor (NASICON) type, or a combination thereof.

The inorganic solid electrolyte particles that can be incorporated into the hybrid electrolyte include, but are not limited to, perovskite-type, NASICON-type, garnet-type and sulfide-type materials. A representative perovskite solid electrolyte is Li₃ₓLa_{2/3-x}TiO₃, which exhibits a lithium-ion conductivity exceeding 10⁻³ S/cm at room temperature. This material has been deemed unsuitable in lithium batteries because of the reduction of Ti⁴⁺ on contact with lithium metal. However, we have found that this material, when dispersed in a polymer, does not suffer from this problem.

The sodium superionic conductor (NASICON)-type compounds include a well-known Na₁₊ₓZr₂SiₓP₃₋ₓO₁₂. These materials generally have an AM₂(PO₄)₃ formula with the A site occupied by Li, Na or K. The M site is usually occupied by Ge, Zr or Ti. In particular, the LiTi₂(PO₄)₃ system has been widely studied as a solid-state electrolyte for the lithium-ion battery. The ionic conductivity of LiZr₂(PO₄)₃ is very low, but can be improved by the substitution of Hf or Sn. This can be further enhanced with substitution to form Li₁₊ₓMₓTi₂₋ₓ(PO₄)₃(M═Al, Cr, Ga, Fe, Sc, In, Lu, Y or La). Al substitution has been demonstrated to be the most effective solid-state electrolyte. The Li₁₊ₓAlₓGe₂₋ₓ(PO₄)₃ system is also an effective solid state due to its relatively wide electrochemical stability window. NASICON-type materials are considered as suitable solid electrolytes for high-voltage solid electrolyte batteries.

Garnet-type materials have the general formula A₃B₂Si₃O₁₂, in which the A and B cations have eightfold and sixfold coordination, respectively. In addition to Li₃M₂Ln₃O₁₂ (M═W or Te), a broad series of garnet-type materials may be used as an additive, including Li₅La₃M₂O₁₂ (M═Nb or Ta), Li₆ALa₂M₂O₁₂ (A═Ca, Sr or Ba; M═Nb or Ta), Li_{5.5}La₃M_{1.75}B_{0.25}O₁₂ (M=Nb or Ta; B═In or Zr) and the cubic systems Li₇La₃Zr₂O₁₂ and Li_{7.06}M₃Y_{0.06}Zr_{1.94}O₁₂ (M═La, Nb or Ta). The Li_{6.5}La₃Zr_{1.75}Te_{0.25}O₁₂ compounds have a high ionic conductivity of 1.02×10⁻³ S/cm at room temperature.

The sulfide-type solid electrolytes include the Li₂S—SiS₂ system. The conductivity in this type of material is 6.9×10⁻⁴ S/cm, which was achieved by doping the Li₂S—SiS₂ system with Li₃PO₄. Other sulfide-type solid-state electrolytes can reach a good lithium-ion conductivity close to 10⁻² S/cm. The sulfide type also includes a class of thio-LISICON (lithium superionic conductor) crystalline material represented by the Li₂S—P₂S₅ system. The chemical stability of the Li₂S—P₂S₅ system is considered as poor, and the material is sensitive to moisture (generating gaseous H₂S). The stability can be improved by the addition of metal oxides. The stability is also significantly improved if the Li₂S—P₂S₅ material is dispersed in an elastic polymer as herein disclosed.

These inorganic solid electrolyte (ISE) particles encapsulated by an elastic electrolyte polymer shell can help enhance the lithium ion conductivity of certain polymers that have a lower ion conductivity than the encapsulated SEI. Preferably and typically, the elastic polymer electrolyte has a lithium ion conductivity no less than 10⁻⁵ S/cm, more desirably no less than 10⁻⁴ S/cm, further preferably no less than 10⁻³ S/cm, and most preferably no less than 10⁻² S/cm.

It should be noted that certain inorganic solid electrolytes (e.g., sulfide type ISE) can have a higher lithium-ion conductivity as compared to certain selected polymers. However, sulfide type ISEs are air-sensitive and air-sensitive and, hence, cannot be combined with an anode active material (e.g., graphite or Si) to form an anode using water as a liquid medium in a commonly used slurry coating process. Furthermore, sulfide-type ISEs have a very narrow electrochemical stability window (e.g., from 1.8-2.5 V relative to Li/Li⁺), making them unsuitable for use in the anode, where lithium ion intercalation occurs at approximately 0.23 V for graphite and 0.5 V for Si (significantly lower than 1.8 V). They are also unsuitable for the cathode since the cathode active material typically operates at 3.2-4.4 V for lithium iron phosphate and all lithium transition metal oxides. We have solved this problem by encapsulating the ISE particles with a polymer electrolyte that typically has a significantly wider electrochemical stability window (e.g., can be from 0 to 4.5 V relative to Li/Li⁺). The polymer protection also enables the ISEs processible using the current lithium-ion cell production processes.

These solid electrolyte particles dispersed in an electrolyte polymer can help enhance the lithium ion conductivity of certain polymers having an intrinsically low ion conductivity.

Preferably and typically, the polymer has a lithium ion conductivity no less than 10⁻⁵ S/cm, more preferably no less than 10⁻⁴ S/cm, and further preferably no less than 10⁻³ S/cm.

The disclosed dipolar lithium battery can be a lithium-ion battery or a lithium metal battery, the latter having lithium metal as the primary anode active material. The lithium metal battery can have lithium metal implemented at the anode when the battery is made. Alternatively, the lithium may be stored in the cathode active material and the anode side is lithium metal-free initially. This is called an anode-less lithium metal battery.

As illustrated in FIG. 3(A), the bipolar anode-less lithium battery is in an as-manufactured or fully discharged state according to certain embodiments of the present disclosure. The battery comprises multiple cells, wherein a cell comprises a separator (e.g., 15a, 15b), a cathode layer (e.g., 16a, 16b) supported on a bipolar current collector (e.g., 18a, 18b), and a neighboring bipolar current collector (e.g., 18b, 18c) having one primary surface (the anode side) initially being free from any lithium metal. Each cathode layer comprises a cathode active material, a conductive additive (not shown), an optional resin binder (not shown), and an electrolyte (dispersed in the entire cathode layer and in contact with the cathode active material). The bipolar current collector (18a, 18b, 18c) supports the cathode layer (16a, 16b) on a primary surface with the opposing primary surface being tentatively free from a lithium metal layer (as manufactured or in a fully discharged state). There is no lithium metal in the anode side of a bipolar current collector when the battery is manufactured.

In a charged state, as illustrated in FIG. 3(B), the battery cell comprises a lithium metal (20a, 20b) plated on the opposing primary surface (the anode side) of a bipolar current collector (18b, 18c), a separator (15a, 15b), and a cathode layer (16a, 16b). The lithium metal comes from the cathode active material (e.g., LiCoO₂ and LiMn₂O₄) that contains Li element when the cathode is made. During a charging step, lithium ions are released from the cathode active material and move to the anode side to deposit onto a primary surface of a bipolar current collector for forming a lithium metal layer, the anode active material.

One unique feature of the presently disclosed bipolar anode-less lithium battery is the notion that there is substantially no anode active material and no lithium metal is present when the battery is made. The commonly used anode active material, such as an intercalation type anode material (e.g., graphite, carbon particles, Si, SiO, Sn, SnO₂, Ge, etc.), P, or any conversion-type anode material, is not included in the battery. The anode only contains a current collector or a protected current collector. No lithium metal (e.g., Li particle, surface-stabilized Li particle, Li foil, Li chip, etc.) is present in the anode when the battery is made; lithium is basically stored in the cathode (e.g., Li element in LiCoO₂, LiMn₂O₄, lithium iron phosphate, lithium polysulfides, lithium polyselenides, NCA, NCM, etc.). During the first charge procedure after the battery is sealed in a housing (e.g., a stainless steel hollow cylinder or an Al/plastic laminated envelop), lithium ions are released from these Li-containing compounds (cathode active materials) in the cathode, travel through the electrolyte/separator into the anode side, and get deposited on the surface of a bipolar current collector. During a subsequent discharge procedure, lithium ions leave this surface and travel back to the cathode, intercalating or inserting into the cathode active material.

Such an anode-less bipolar battery is much simpler and more cost-effective to produce as compared to the conventional lithium-ion battery since there is no need to have a layer of anode active material (e.g., graphite particles, along with a conductive additive and a binder) pre-coated on the Cu foil surfaces via the conventional slurry coating and drying procedures. The anode materials and anode active layer manufacturing costs can be saved. Furthermore, since there is no anode active material layer (otherwise typically 40-200 μm thick), the weight and volume of the cell can be significantly reduced, thereby increasing the gravimetric and volumetric energy density of the battery. This advantage is in addition to the advantage that there are substantially no connecting wires or cables between two unit cells, further saving the weight, volume, and cost.

Another important advantage of the anode-less battery is the notion that there is no lithium metal in the anode when a lithium metal cell is made. Lithium metal (e.g., Li metal foil and particles) is highly sensitive to air moisture and oxygen and notoriously known for its difficulty and danger to handle during manufacturing of a Li metal battery. The manufacturing facilities must be equipped with a special class of dry rooms, which are expensive and significantly increase the battery cell costs.

The primary surface at the anode side of a bipolar current collector may be is deposited with multiple particles or coating of a lithium-attracting metal (lithiophilic metal), wherein the lithium-attracting metal, preferably having a diameter or thickness from 1 nm to 10 μm, is selected from Au. Ag, Mg, Zn, Ti, K. Al, Fe, Mn, Co, Ni, Sn, V, Cr, an alloy thereof, or a combination thereof. This deposited metal layer may be further deposited with a layer of protective polymer that covers and protects the multiple particles or coating of the lithiophilic metal. Alternatively, the lithiophilic metal may be protected by a graphene layer that comprises graphene balls and/or graphene foam. Preferably, the graphene layer has a thickness from 1 nm to 50 μm and/or has a specific surface area from 5 to 1000 m²/g (more preferably from 10 to 500 m²/g). It may be noted that this protective graphene layer (for protecting the lithiophilic metal) is separate and different from the graphene or expanded graphite layer that is directly deposited onto the primary surfaces of a bipolar current collector to prevent diffusion of lithium ions through the metal foil; this graphene layer is further discussed below:

A bipolar current collector may be coated with a graphene or expanded graphite layer on one primary surface or both primary surfaces to protect against diffusion of lithium ions into the current collector (e.g., a metal foil). This graphene layer may comprise a graphene layer produced via chemical vapor deposition (CVD). The graphene layer may comprise graphene sheets selected from single-layer or few-layer graphene, wherein the few-layer graphene sheets are commonly defined to have 2-10 layers of stacked graphene planes having an inter-plane spacing d₀₀₂ from 0.3354 nm to 0.6 nm as measured by X-ray diffraction. The single-layer or few-layer graphene sheets may contain a pristine graphene material having essentially zero % of non-carbon elements, or a non-pristine graphene material having 0.001% to 45% by weight of non-carbon elements. The non-pristine graphene may be selected from graphene oxide, reduced graphene oxide, graphene fluoride, graphene chloride, graphene bromide, graphene iodide, hydrogenated graphene, nitrogenated graphene, doped graphene, chemically functionalized graphene, or a combination thereof.

For a bipolar lithium-ion battery featuring the presently disclosed electrolyte, there is no particular restriction on the selection of an anode active material. The anode active material may be selected from the group consisting of: (a) silicon (Si), germanium (Ge), tin (Sn), lead (Pb), antimony (Sb), phosphorus (P), bismuth (Bi), zinc (Zn), aluminum (Al), titanium (Ti), nickel (Ni), cobalt (Co), and cadmium (Cd); (b) alloys or intermetallic compounds of Si, Ge, Sn, Pb, Sb, Bi, Zn, Al, Ti, Ni, Co, or Cd with other elements; (c) oxides, carbides, nitrides, sulfides, phosphides, selenides, and tellurides of Si, Ge, Sn, Pb, Sb, Bi, Zn, Al, Ti, Fe, Ni, Co, V, or Cd, and their mixtures, composites, or lithium-containing composites; (d) salts and hydroxides of Sn; (e) lithium titanate, lithium manganate, lithium aluminate, lithium titanium niobate, lithium-containing titanium oxide, lithium transition metal oxide, ZnCo₂O₄; (f) carbon or graphite particles (g) prelithiated versions thereof; and (h) combinations thereof.

A highly significant observation is that the polymer derived (polymerized) from an otherwise volatile solvent (monomer) can dramatically curtail the amount of volatile solvent molecules that can escape into the vapor phase in a thermodynamic equilibrium condition. In many cases, this has effectively prevented any flammable gas molecules from initiating a flame even at an extremely high temperature. The flash point of the quasi-solid or solid-state electrolyte is typically at least 100 degrees (often>150 degrees) higher than the flash point of the neat organic solvent without polymerization. In most of the cases, either the flash point is significantly higher than 200° C. or no flash point can be detected. The electrolyte just would not catch on fire. Furthermore, any accidentally initiated flame does not sustain for longer than 3 seconds. This is a highly significant discovery, considering the notion that fire and explosion concern has been a major impediment to widespread acceptance of battery-powered electric vehicles. This new technology could significantly impact the emergence of a vibrant EV industry.

In addition to the non-flammability and high lithium ion transference numbers, there are several additional benefits associated with using the presently disclosed quasi-solid or solid-state electrolytes. As one example, these electrolytes can significantly enhance cycling and safety performance of rechargeable lithium batteries through effective suppression of lithium dendrite growth. Due to a good contact between the electrolyte and an electrode, the interfacial impedance can be significantly reduced. Additionally, the local high viscosity induced by the presence of a polymer in the anode can increase the pressure from the electrolyte to inhibit dendrite growth, potentially resulting in a more uniform deposition of lithium ions on the surface of the anode. The high viscosity could also limit anion convection near the deposition area, promoting more uniform deposition of Li ions. These reasons, separately or in combination, are believed to be responsible for the notion that no dendrite-like feature has been observed with any of the large number of rechargeable lithium cells that we have investigated thus far.

As another benefit example, this electrolyte is capable of inhibiting lithium polysulfide dissolution at the cathode and migration to the anode of a Li—S cell, thus overcoming the polysulfide shuttle phenomenon and allowing the cell capacity not to decay significantly with time. Consequently, a coulombic efficiency nearing 100% along with long cycle life can be achieved. When a concentrated electrolyte or crosslinked polymer is used, the solubility of lithium polysulfide will be reduced significantly.

The lithium salt may be selected from lithium perchlorate (LiClO₄), lithium hexafluorophosphate (LiPF₆), lithium borofluoride (LiBF₄), lithium hexafluoroarsenide (LiAsF₆), lithium trifluoro-metasulfonate (LiCF₃SO₃), bis-trifluoromethyl sulfonylimide lithium (LiN(CF₃SO₂)₂), lithium bis(oxalato)borate (LiBOB), lithium oxalyldifluoroborate (LiBF₂C₂O₄), lithium oxalyldifluoroborate (LiBF₂C₂O₄), lithium nitrate (LiNO₃), Li-Fluoroalkyl-Phosphates (LiPF₃(CF₂CF₃)₃), lithium bisperfluoro-ethysulfonylimide (LiBETI), lithium bis(trifluoromethanesulphonyl)imide, lithium bis(fluorosulphonyl)imide, lithium trifluoromethanesulfonimide (LiTFSI), an ionic liquid lithium salt, or a combination thereof.

The ionic liquid is composed of ions only. Ionic liquids are low melting temperature salts that are in a molten or liquid state when above a desired temperature. For instance, an ionic salt is considered as an ionic liquid if its melting point is below 100° C. If the melting temperature is equal to or lower than room temperature (25° C.), the salt is referred to as a room temperature ionic liquid (RTIL). The IL-based lithium salts are characterized by weak interactions, due to the combination of a large cation and a charge-delocalized anion. This results in a low tendency to crystallize due to flexibility (anion) and asymmetry (cation).

Some ILs may be used as a co-solvent (not as a salt) to work with the first organic solvent of the present invention. A well-known ionic liquid is formed by the combination of a 1-ethyl-3-methyl-imidazolium (EMI) cation and an N,N-bis(trifluoromethane)sulphonamide (TFSI) anion. This combination gives a fluid with an ionic conductivity comparable to many organic electrolyte solutions, a low decomposition propensity and low vapor pressure up to ˜300-400° C. This implies a generally low volatility and non-flammability and, hence, a much safer electrolyte solvent for batteries.

Ionic liquids are basically composed of organic or inorganic ions that come in an unlimited number of structural variations owing to the preparation ease of a large variety of their components. Thus, various kinds of salts can be used to design the ionic liquid that has the desired properties for a given application. These include, among others, imidazolium, pyrrolidinium and quaternary ammonium salts as cations and bis(trifluoromethanesulphonyl) imide, bis(fluorosulphonyl)imide and hexafluorophosphate as anions. Useful ionic liquid-based lithium salts (not solvent) may be composed of lithium ions as the cation and bis(trifluoromethanesulphonyl)imide, bis(fluorosulphonyl)imide and hexafluorophosphate as anions. For instance, lithium trifluoromethanesulfonimide (LiTFSI) is a particularly useful lithium salt.

Based on their compositions, ionic liquids come in different classes that include three basic types: aprotic, protic and zwitterionic types, each one suitable for a specific application. Common cations of room temperature ionic liquids (RTILs) include, but are not limited to, tetraalkylammonium, di, tri, and tetra-alkylimidazolium, alkylpyridinium, dialkyl-pyrrolidinium, dialkylpiperidinium, tetraalkylphosphonium, and trialkylsulfonium. Common anions of RTILs include, but are not limited to, BF₄⁻, B(CN)₄⁻, CH₃BF₃⁻, CH₂CHBF₃⁻, CF₃BF₃⁻, C₂F₅BF₃⁻, n-C₃F₇BF₃⁻, n-C₄F₉BF₃⁻, PF₆⁻, CF₃CO₂⁻, CF₃SO₃, N(SO₂CF₃)₂⁻, N(COCF₃)(SO₂CF₃)⁻, N(SO₂F)₂⁻, N(CN)₂⁻, C(CN)₃⁻, SCN⁻, SeCN⁻, CuCl₂⁻, AlCl₄⁻, F(HF)_{2.3}⁻, etc. Relatively speaking, the combination of imidazolium- or sulfonium-based cations and complex halide anions such as AlCl₄⁻, BF₄⁻, CF₃CO₂⁻, CF₃SO₃⁻, NTf₂⁻, N(SO₂F)₂⁻, or F(HF)_{2.3} results in RTILs with good working conductivities.

RTILs can possess archetypical properties such as high intrinsic ionic conductivity, high thermal stability, low volatility, low (practically zero) vapor pressure, non-flammability, the ability to remain liquid at a wide range of temperatures above and below room temperature, high polarity, high viscosity, and wide electrochemical windows. These properties, except for the high viscosity, are desirable attributes when it comes to using an RTIL as an electrolyte co-solvent in a rechargeable lithium cell.

There is also no restriction on the type of the cathode materials that can be used in practicing the present disclosure. For Li—S cells, the cathode active material may contain lithium polysulfide or sulfur. If the cathode active material includes lithium-containing species (e.g., lithium polysulfide) when the cell is made, there is no need to have a lithium metal pre-implemented in the anode.

There are no particular restrictions on the types of cathode active materials that can be used in the presently disclosed lithium battery, which can be a primary battery or a secondary battery. The rechargeable lithium metal or lithium-ion cell may preferably contain a cathode active material selected from, as examples, a layered compound LiMO₂, spinel compound LiM₂O₄, olivine compound LiMPO₄, silicate compound Li₂MSiO₄, Tavorite compound LiMPO₄F, borate compound LiMBO₃, or a combination thereof, wherein M is a transition metal or a mixture of multiple transition metals.

In a rechargeable lithium cell, the cathode active material may be selected from a metal oxide, a metal oxide-free inorganic material, an organic material, a polymeric material, sulfur, lithium polysulfide, selenium, or a combination thereof. The metal oxide-free inorganic material may be selected from a transition metal fluoride, a transition metal chloride, a transition metal dichalcogenide, a transition metal trichalcogenide, or a combination thereof. In a particularly useful embodiment, the cathode active material is selected from FeF₃, FeCl₃, CuCl₂, TiS₂, TaS₂, MoS₂, NbSe₃, MnO₂, CoO₂, an iron oxide, a vanadium oxide, or a combination thereof, if the anode contains lithium metal as the anode active material. The vanadium oxide may be preferably selected from the group consisting of VO₂, LiₓVO₂, V₂O₅, LiₓV₂O₅, V₃O₈, LiₓV₃O₈. LiₓV₃O₇, V₄O₉, LiₓV₄O₉, V₆O₁₃, LiₓV₆O₁₃, their doped versions, their derivatives, and combinations thereof, wherein 0.1<x<5. For those cathode active materials containing no Li element therein, there must be a lithium source implemented in the cathode side to begin with. This can be any compound that contains a high lithium content, or a lithium metal alloy, etc.

In a rechargeable lithium cell (e.g., the lithium-ion battery cell), the cathode active material may be selected to contain a layered compound LiMO₂, spinel compound LiM₂O₄, olivine compound LiMPO₄, silicate compound Li₂MSiO₄, Tavorite compound LiMPO₄F, borate compound LiMBO₃, or a combination thereof, wherein M is a transition metal or a mixture of multiple transition metals.

Particularly desirable cathode active materials comprise lithium nickel manganese oxide (LiNiₐMn₂₋ₐO₄, 0<a<2), lithium nickel manganese cobalt oxide (NCM or LiNiₙMnₘCo₁₋ₙ₋ₘO₂, 0<n<1, 0<m<1, n+m<1), lithium nickel cobalt aluminum oxide (NCA or LiNi_{c}Co_{d}Al_{1-c-d}O₂, 0<c<1, 0<d<1, c+d<1), lithium manganate (LiMn₂O₄), lithium iron phosphate (LiFePO₄), lithium manganese oxide (LiMnO₂), lithium cobalt oxide (LiCoO₂), lithium nickel cobalt oxide (LiNiₚCo₁₋ₚO₂, 0<p<1), or lithium nickel manganese oxide (LiNi_{q}Mn_{2-q}O₄, 0<q<2).

In a preferred lithium metal secondary battery, the cathode active material preferably contains an inorganic material selected from: (a) bismuth selenide or bismuth telluride, (b) transition metal dichalcogenide or trichalcogenide, (c) sulfide, selenide, or telluride of niobium, zirconium, molybdenum, hafnium, tantalum, tungsten, titanium, cobalt, manganese, iron, nickel, or a transition metal; (d) boron nitride, or (e) a combination thereof. Again, for those cathode active materials containing no Li element therein, there must be a lithium source implemented in the cathode side to begin with.

In another preferred bipolar rechargeable lithium battery (e.g. a lithium metal secondary battery or a lithium-ion battery), the cathode active material contains an organic material or polymeric material selected from Poly(anthraquinonyl sulfide) (PAQS), lithium oxocarbons (including squarate, croconate, and rhodizonate lithium salts), oxacarbon (including quinines, acid anhydride, and nitrocompound), 3,4,9,10-perylenetetracarboxylic dianhydride (PTCDA), poly(anthraquinonyl sulfide), pyrene-4,5,9,10-tetraone (PYT), polymer-bound PYT, Quino(triazene), redox-active organic material (redox-active structures based on multiple adjacent carbonyl groups (e.g., “C₆O₆”-type structure, oxocarbons), Tetracyanoquinodimethane (TCNQ), tetracyanoethylene (TCNE), 2,3,6,7,10,11-hexamethoxytriphenylene (HMTP), poly(5-amino-1,4-dyhydroxy anthraquinone) (PADAQ), phosphazene disulfide polymer ([(NPS₂)₃]n), lithiated 1,4,5,8-naphthalenetetraol formaldehyde polymer. Hexaazatrinaphtylene (HATN), Hexaazatriphenylene hexacarbonitrile (HAT(CN)6), 5-Benzylidene hydantoin, Isatine lithium salt, Pyromellitic diimide lithium salt, tetrahydroxy-p-benzoquinone derivatives (THQLi₄), N,N′-diphenyl-2,3,5,6-tetraketopiperazine (PHP), N,N′-diallyl-2,3,5,6-tetraketopiperazine (AP), N,N′-dipropyl-2,3,5,6-tetraketopiperazine (PRP), a thioether polymer, a quinone compound, 1,4-benzoquinone, 5,7,12,14-pentacenetetrone (PT), 5-amino-2,3-dihydro-1,4-dyhydroxy anthraquinone (ADDAQ), 5-amino-1,4-dyhydroxy anthraquinone (ADAQ), calixquinone. Li₄C₆O₆. Li₂C₆O₆, Li₆C₆O₆, or a combination thereof.

The thioether polymer may be selected from Poly[methanetetryl-tetra(thiomethylene)](PMTTM), Poly(2,4-dithiopentanylene) (PDTP), or Poly(ethene-1,1,2,2-tetrathiol) (PETT) as a main-chain thioether polymer, in which sulfur atoms link carbon atoms to form a polymeric backbones. The side-chain thioether polymers have polymeric main-chains that include of conjugating aromatic moieties, but having thioether side chains as pendants. Among them Poly(2-phenyl-1,3-dithiolane) (PPDT), Poly(1,4-di(1,3-dithiolan-2-yl)benzene) (PDDTB), poly(tetrahydrobenzodithiophene) (PTHBDT), and poly[1,2,4,5-tetrakis(propylthio)benzene](PTKPTB) have a polyphenylene main chain, linking thiolane on benzene moieties as pendants. Similarly, poly[3,4(ethylenedithio)thiophene](PEDTT) has polythiophene backbone, linking cyclo-thiolane on the 3,4-position of the thiophene ring.

In yet another preferred bipolar rechargeable lithium battery, the cathode active material contains a phthalocyanine compound selected from copper phthalocyanine, zinc phthalocyanine, tin phthalocyanine, iron phthalocyanine, lead phthalocyanine, nickel phthalocyanine, vanadyl phthalocyanine, fluorochromium phthalocyanine, magnesium phthalocyanine, manganous phthalocyanine, dilithium phthalocyanine, aluminum phthalocyanine chloride, cadmium phthalocyanine, chlorogallium phthalocyanine, cobalt phthalocyanine, silver phthalocyanine, a metal-free phthalocyanine, a chemical derivative thereof, or a combination thereof. This class of lithium secondary batteries has a high capacity and high energy density. Again, for those cathode active materials containing no Li element therein, there must be a lithium source implemented in the cathode side to begin with.

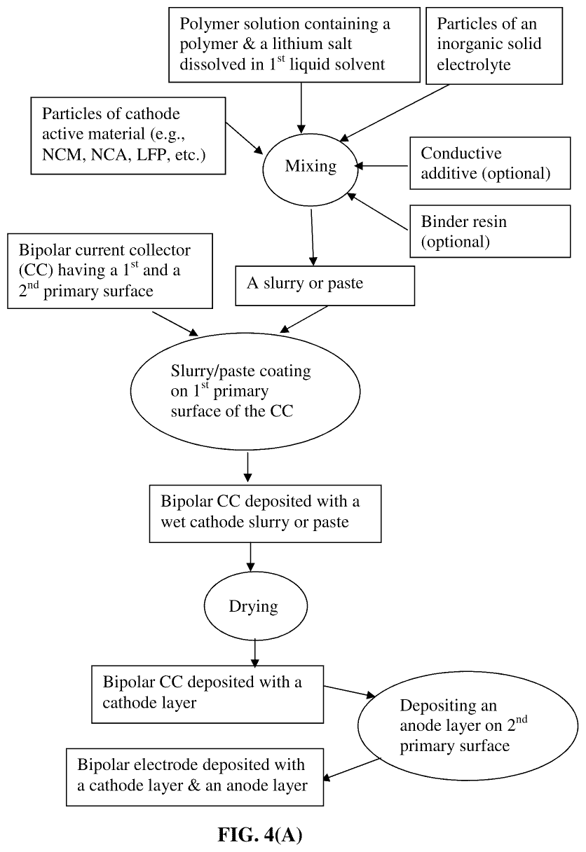

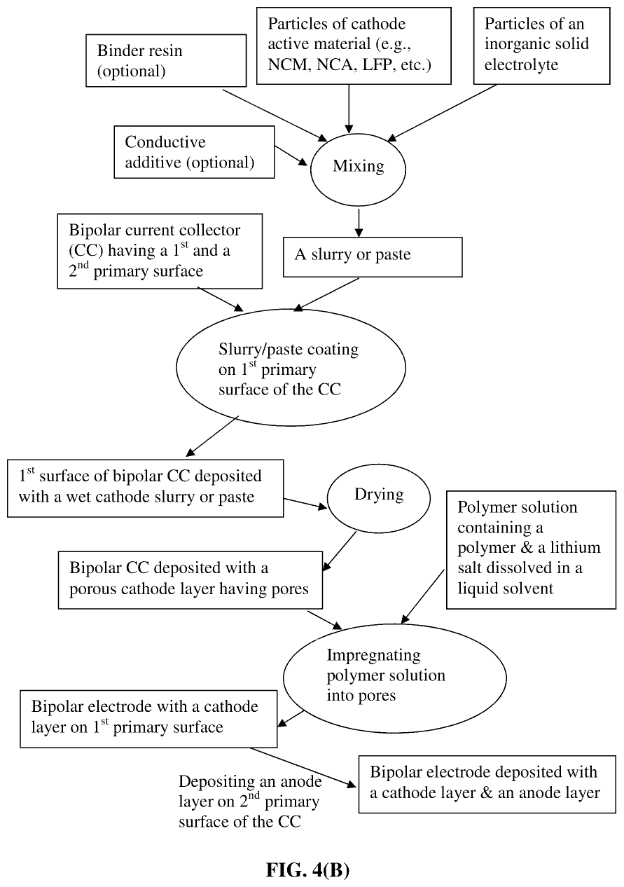

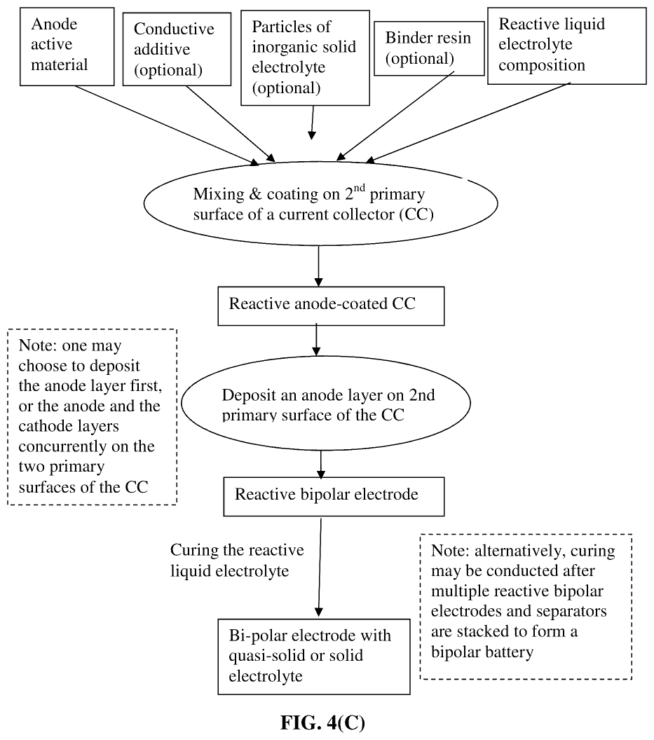

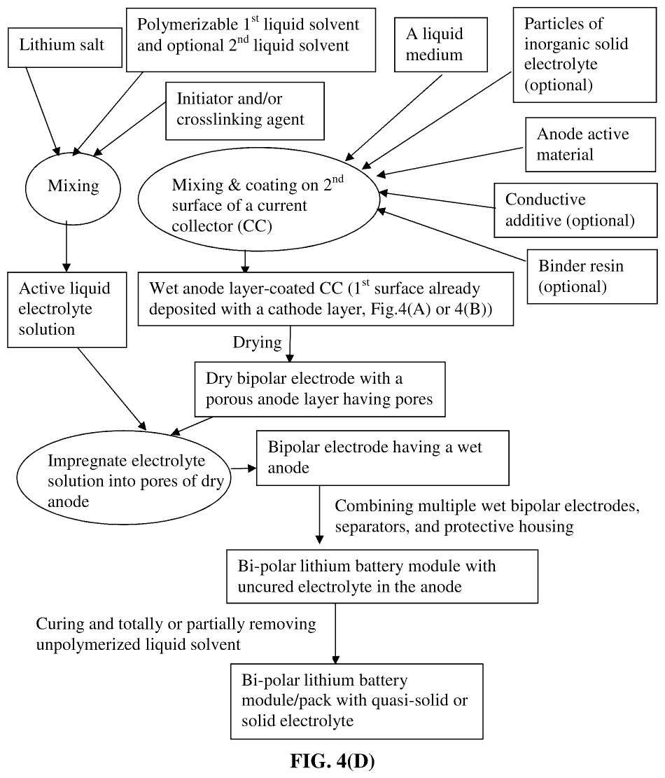

The present disclosure also provides a method of producing the disclosed bipolar electrode and bipolar battery pack, as illustrated in FIGS. 4(A), 4(B), 4(C), and 4(D).

The present disclosure also provides a method of producing the bipolar battery pack. In certain embodiments, the method comprises:
(a) Providing a first set of multiple bipolar electrodes and at least one layer or multiple layers of ion-permeable separator or solid-state electrolyte, wherein at least one of the bipolar electrodes is prepared by: (A) providing a current collector comprising a conductive material foil having a thickness from 10 nm to 100 μm and two opposing primary surfaces; (B) depositing a positive electrode layer on a first primary surface, wherein the positive electrode layer comprises a mixture of particles of a cathode active material, an optional conductive additive, an optional binder resin, particles of a solid inorganic solid-state electrolyte, and a first polymer electrolyte; and (C) providing either (i) a negative electrode layer deposited on the opposing (second) primary surface wherein the negative electrode layer comprises a lithium metal layer or a layer of a mixture of particles of an anode active material, an optional conductive additive, an optional binder resin, optional particles of a solid inorganic solid-state electrolyte, and a second polymer electrolyte or (ii) initially no negative electrode layer deposited on said opposing primary surface (for the purpose of forming an anodeless lithium metal battery);
(b) Stacking the multiple bipolar electrodes sequentially with the layers of ion-permeable separator or solid-state electrolyte to connect multiple bipolar electrodes in series to form a module in such a manner that a layer of ion-permeable separator or solid-state electrolyte is disposed between the negative electrode layer of a bipolar electrode and the positive electrode layer of a neighboring bipolar electrode; and
(c) Optionally encasing the module with a protective housing element to form a pack.

In certain embodiments, step b) further comprises forming at least another module in a similar manner and connecting the resulting multiple modules in parallel, and step c) comprises encasing the parallel-connected multiple modules with a protective housing element to form a pack.

As schematically illustrated in FIG. 4(B), the positive electrode layer in step (a) may be produced by (i) mixing and dispersing particles of a cathode active material, particles of a solid inorganic solid-state electrolyte, an optional resin binder, and an optional conductive additive in a liquid medium (e.g., NMP) to form a liquid slurry; (ii) depositing a layer of slurry on the first primary surface of the current collector; (iii) removing the liquid medium from the slurry layer to obtain a porous positive electrode layer containing from 1% to 50% by volume of pores; (iv) preparing a first polymer solution comprising a polymer and a lithium salt dissolved in a first liquid solvent having a polymer-to-lithium salt weight ratio of from 1/100 to 100/1, wherein the polymer has a lithium-ion conductivity no less than 10⁻⁸ S/cm; and (v) impregnating the polymer solution into pores of the porous positive electrode layers and partially or totally removing the first liquid solvent from the positive electrode layer to obtain the bipolar electrode. In this procedure, steps (i)-(iii) is similar to the conventional slurry coating process for producing a cathode (positive electrode) of a lithium-ion cell. However, steps (iv) and (v) are totally new and distinct from the remaining procedures of the conventional lithium ion cell production process.

Alternatively, as schematically illustrated in FIG. 4(A), the positive electrode layer in step a) may be produced by (i) mixing, dispersing, or dissolving particles of a cathode active material, particles of a solid inorganic solid-state electrolyte, an optional resin binder, an optional conductive additive, and a first electrolyte polymer in a first liquid solvent to form a liquid slurry, wherein the first electrolyte polymer has a lithium-ion conductivity no less than 10⁻⁸ S/cm; (ii) depositing a layer of slurry on the first primary surface of the current collector, and (iii) partially or completely removing the first liquid solvent from the slurry layer to obtain the positive electrode layer.

Preferably, the process is a roll-to-roll process wherein the process comprises (i) continuously feeding a layer of the solid substrate (e.g. graphene-coated Al foil) from a feeder roller to a dispensing zone where the polymer slurry (e.g., mixture of a polymer electrolyte composition, cathode active material particles, a conductive additive, and a lithium salt dispersed/dissolved in a liquid solvent) is dispensed (e.g., coated, casted, sprayed, or printed) and deposited onto a primary surface of the solid substrate to form a continuous layer of the polymer slurry; (ii) moving the layer of the polymer slurry into a drying zone where the polymer slurry is exposed to heat, microwave, infrared (IR) light, and/or vacuum pump-assisted vaporization to remove the liquid solvent to form a continuous layer of positive electrode-coated current collector, (iii) depositing an anode layer onto the opposing primary surface to form the bipolar electrode; and (iv) collecting the bipolar electrode on a winding roller. This process is conducted in a reel-to-reel manner.

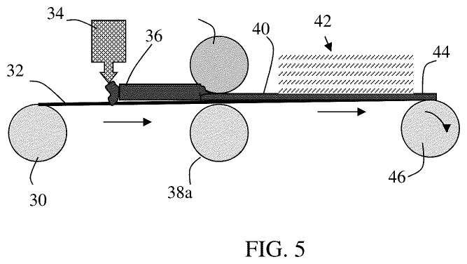

As illustrated in FIG. 5, the roll-to-roll process may begin with continuously feeding a solid substrate layer 32 (e.g., graphene- or expanded graphite-coated Al foil) from a feeder roller 30. A dispensing device 34 is operated to dispense and deposit a polymer slurry layer 36 (e.g., wet cathode layer) onto the solid substrate layer 32, which is driven toward a pair of rollers (38a, 38b). These rollers are an example of a provision to regulate or control the thickness of the polymer slurry layer 40. The polymer slurry layer 40, supported on the solid substrate, is driven to move through a heating/vaporizing zone 42 which is provided with a heating or pumping means (heat, IR, vacuum pump, etc.). The partially or fully solidified polymer composite 44 is collected on a winding roller 46. An anode layer may be deposited before or after the cathode layer is dried so that the anode layer may be dried/solidified concurrently or separately. The anode layer may be just a layer of lithium metal or a lithium metal-protecting polymer that can be deposited using vapor deposition, sputtering, spraying, etc. One may unwind the roll at a later stage.

The process may further comprise cutting and trimming the continuous layer of bipolar electrode into one or multiple pieces of bipolar electrodes. The process may further comprise combining multiple bipolar electrodes and separators into a bipolar lithium battery modules and pack.

The negative electrode (anode) can be produced in a similar manner, similar to those processes described in FIG. 4(A) or 4(B).

For instance, as illustrated in FIG. 4(D), the negative electrode (anode) layer in step (a) is produced by (i) mixing and dispersing particles of an anode active material, optional particles of a solid inorganic solid-state electrolyte, an optional resin binder, and an optional conductive additive in a liquid medium to form a liquid slurry; (ii) depositing a layer of slurry on a second primary surface of the current collector; (iii) removing the liquid medium from the slurry layer to obtain the negative electrode layer containing from 1% to 50% by volume of pores; and (iv) impregnating the pores with a polymer electrolyte. Step (iv) may be accomplished by preparing a second polymer solution comprising a second polymer and a lithium salt dissolved in a second liquid solvent (the same as or different than the first liquid solvent) having a polymer-to-lithium salt weight ratio of from 1/100 to 100/1, wherein the second polymer (the same as or different than the first polymer) has a lithium-ion conductivity no less than 10⁻⁸ S/cm; and (v) impregnating the second polymer solution into pores of the porous positive electrode layers and partially or totally removing the second liquid solvent from the negative electrode layer to obtain the bipolar electrode.

Alternatively, the negative electrode layer in step (a) may be produced by (i) mixing, dispersing, or dissolving particles of an anode active material, optional particles of a solid inorganic solid-state electrolyte, an optional resin binder, an optional conductive additive, and a electrolyte polymer in a liquid solvent to form a liquid slurry; (ii) depositing a layer of slurry on the opposing primary surface of the current collector; and (iii) partially or completely removing the liquid solvent from the slurry layer to obtain the negative electrode layer.

As schematically illustrated in FIG. 4(C), In some embodiments, the negative electrode layer in step (a) may be produced by (i) depositing a reactive anode layer onto a second primary surface of the current collector to form a reactive anode layer-coated current collector, wherein the reactive anode layer comprises a mixture of multiple particles of an anode active material, an optional conductive additive, and a reactive liquid electrolyte composition comprising at least a polymerizable first liquid solvent, a lithium salt dissolved in the first liquid solvent, and a crosslinking agent and/or an initiator, wherein the first liquid solvent occupies from 1% to 99% by weight based on the total weight of the reactive liquid electrolyte composition; and (ii) partially or totally polymerizing the first liquid solvent to obtain an anode active layer coated on the current collector wherein from 30% to 100% by weight of the polymerizable first liquid solvent is polymerized to become a quasi-solid or solid-state electrolyte that chemically bonds the multiple particles of the anode active material and the conductive additive together to form an anode active layer that adheres to the second primary surface.

The first polymerizable liquid solvent may be selected from the group consisting of vinylene carbonate, ethylene carbonate, fluoroethylene carbonate, vinyl sulfite, vinyl ethylene sulfite, vinyl ethylene carbonate, 1,3-propyl sultone, 1,3-acrylic-sultones, methyl ethylene sulfone, methyl vinyl sulfone, ethyl vinyl sulfone, methyl methacrylate, vinyl acetate, acrylamide, 1,3-dioxolane (DOL), fluorinated ethers, fluorinated esters, sulfones, sulfides, nitriles, sulfates, siloxanes, silanes, phosphates, phosphonates, phosphinates, phosphines, phosphine oxides, phosphonic acids, phosphorous acid, phosphites, phosphoric acids, phosphazene compounds, derivatives thereof, and combinations thereof.

In some preferred embodiments, the process associated with the method (step (a), for instance) is conducted in a roll-to-roll manner to produce a roll of bipolar electrode. One can then un-wind the roll, cut and trim into a desired number of bipolar electrodes of desired dimensions. Alternatively, one can produce one or multiple bipolar electrodes of desired dimensions at a time using a machine system. Slurry coating, casting or spraying and drying machines are well-known in the art.

The disclosure further provides a method of producing the disclosed bipolar battery pack, the method comprising:
a. Providing a first set of multiple bipolar electrodes and at least one layer or multiple layers of ion-permeable separator or solid-state electrolyte, wherein at least one of the bipolar electrodes is prepared by: (A) providing a first current collector comprising a first conductive material foil having a thickness from 10 nm to 100 μm and two opposing primary surfaces, herein after referred to as the first and the second primary surface, respectively; (B) depositing a positive electrode layer on the first primary surface to form a first half of the bipolar electrode, wherein the positive electrode layer comprises a mixture of particles of a cathode active material, an optional conductive additive, an optional binder resin, particles of a solid inorganic solid-state electrolyte, and a first polymer electrolyte and wherein the second surface is not deposited with a positive electrode layer or a negative electrode layer; and (C) providing a second current collector comprising a second conductive material foil, different than the first conductive material, having a thickness from 10 nm to 100 μm and two opposing primary surfaces, hereinafter referred to as the third and the fourth primary surface, respectively; and (D) either depositing a negative electrode layer on the third primary surface on the third primary surface or initially having no negative electrode layer deposited on said third primary surface to obtain a second half of the bipolar electrode, wherein the negative electrode layer comprises (i) a lithium metal layer and/or (ii) a layer of a mixture of particles of an anode active material, an optional conductive additive, an optional binder resin, optional particles of a solid inorganic solid-state electrolyte, and a second polymer electrolyte, and wherein the fourth surface is not deposited with a positive electrode layer or negative electrode layer; and (E) combining the first half of the bipolar electrode and the second half of the bipolar electrode to form the bipolar electrode wherein the second primary surface and the fourth primary surface are mechanically compressed or chemically bonded together (e.g., through an adhesive);
b. Stacking the multiple bipolar electrodes sequentially with the layers of ion-permeable separator or solid-state electrolyte to connect multiple bipolar electrodes in series to form a module in such a manner that a layer of ion-permeable separator or solid-state electrolyte is disposed between the negative electrode layer of a bipolar electrode and the positive electrode layer of a neighboring bipolar electrode; and
c. Optionally encasing the module with a housing element to form a pack.
   In some embodiments, step (b) further comprises forming at least another module in a similar manner and connecting the resulting multiple modules in parallel, and step c) comprises encasing the parallel-connected multiple modules with a protective housing element to form a pack. Optionally, there can be partitioning walls installed between modules inside a pack.

Preferably, the process is a roll-to-roll process wherein the process comprises (i) continuously feeding a layer of the solid substrate (e.g. graphene-coated Al foil) from a feeder roller to a dispensing zone where the reactive mass (e.g., mixture of a reactive electrolyte composition, cathode active material particles, and conductive filler) is dispensed and deposited onto a primary surface of the solid substrate to form a continuous layer of the reactive mass; (ii) moving the layer of the reactive mass into a reacting zone where the reactive mass is exposed to heat, ultraviolet (UV) light, or high-energy radiation to polymerize and/or cure the reactive mass to form a continuous layer of electrode-coated current collector, (iii) depositing an anode layer onto the opposing primary surface (cathode or anode) to form the bipolar electrode; and (iv) collecting the bipolar electrode on a winding roller. This process is conducted in a reel-to-reel manner.

In certain embodiments, as illustrated in FIG. 5, the roll-to-roll process may begin with continuously feeding a solid substrate layer 32 (e.g., graphene- or expanded graphite-coated Al foil) from a feeder roller 30. A dispensing device 34 is operated to dispense and deposit a polymer solution-based slurry/paste (e.g., cathode active material particles, particles of an inorganic solid electrolyte, conductive additive, and a polymer solution comprising a polymer and a lithium salt dissolved in a liquid medium) or a reactive mass 36 (e.g., reactive or curable cathode layer) onto the solid substrate layer 32, which is driven toward a pair of rollers (38a, 38b). These rollers are an example of a provision to regulate or control the thickness of the reactive mass 40. The slurry/paste layer or reactive mass 40, supported on the solid substrate, is driven to move through a reacting zone 42 which is provided with a heating or curing means (heat, UV. IP, high energy radiation, etc.). The partially or fully cured or solidified polymer composite 44 is collected on a winding roller 46. An anode layer may be deposited before or after the cathode layer is cured so that the anode layer may be cured or solidified concurrently or separately. The anode layer may be just a layer of lithium metal or a lithium metal-protecting polymer that can be deposited using vapor deposition, sputtering, spraying, etc. One may unwind the roll at a later stage.

The process may further comprise cutting and trimming the continuous layer of bipolar electrode into one or multiple pieces of bipolar electrodes. The process may further comprise combining multiple bipolar electrodes and separators into a bipolar lithium battery.

The following examples are presented primarily for the purpose of illustrating the best mode practice of the present invention, not to be construed as limiting the scope of the present invention. In the present study, the conductive additive in the electrodes was typically selected from carbon black or acetylene black (e.g., Super-P), carbon nanotubes (CNTs), or graphene sheets, unless otherwise specified.

### EXAMPLE 1: Preparation of Inorganic Solid Electrolyte (ISE) Powder, Lithium Nitride Phosphate Compound (LIPON)

Particles of Li₃PO₄ (average particle size 4 μm) and urea were prepared as raw materials; 5 g each of Li₃PO₄ and urea was weighed and mixed in a mortar to obtain a raw material composition. Subsequently, the raw material composition was molded into 1 cm×1 cm×10 cm rod with a molding machine, and the obtained rod was put into a glass tube and evacuated. The glass tube was then subjected to heating at 500° C. for 3 hours in a tubular furnace to obtain a lithium nitride phosphate compound (LIPON). The compound was ground in a mortar into a powder form. These ISE particles can be combined with a polymer to form hybrid solid-state electrolyte particulates for use in an anode, a cathode, and/or a separator.

### EXAMPLE 2: Preparation of Solid Electrolyte Powder, Lithium Superionic Conductors with the Li₁₀GeP₂S₁₂ (LGPS)-Type Structure

The starting materials, Li₂S and SiO₂ powders, were milled to obtain fine particles using a ball-milling apparatus. These starting materials were then mixed together with P₂S₅ in the appropriate molar ratios in an Ar-filled glove box. The mixture was then placed in a stainless steel pot, and milled for 90 min using a high-intensity ball mill. The specimens were then pressed into pellets, placed into a graphite crucible, and then sealed at 10 Pa in a carbon-coated quartz tube. After being heated at a reaction temperature of 1,000° C. for 5 h, the tube was quenched into ice water. The resulting inorganic solid electrolyte material was then subjected to grinding in a mortar to form a powder sample to be later added as inorganic solid electrolyte particles encapsulated by an intended polymer electrolyte shell.

### EXAMPLE 3: Preparation of Garnet-Type Inorganic Solid Electrolyte Powder

The synthesis of the c-Li_{6.25}Al_{0.25}La₃Zr₂O₁₂ was based on a modified sol-gel synthesis-combustion method, resulting in sub-micron-sized particles after calcination at a temperature of 650° C. (J. van den Broek, S. Afyon and J. L. M. Rupp, Adv. Energy Mater., 2016, 6, 1600736).

For the synthesis of cubic garnet particles of the composition c-Li_{6.25}Al_{0.25}La₃Zr₂O₁₂, stoichiometric amounts of LiNO₃, Al(NO₃)₃-9H₂O, La(NO₃)₃-6(H₂O), and zirconium (IV) acetylacetonate were dissolved in a water/ethanol mixture at temperatures of 70° C. To avoid possible Li-loss during calcination and sintering, the lithium precursor was taken in a slight excess of 10 wt % relative to the other precursors. The solvent was left to evaporate overnight at 95° C. to obtain a dry xerogel, which was ground in a mortar and calcined in a vertical tube furnace at 650° C. for 15 h in alumina crucibles under a constant synthetic airflow. Calcination directly yielded the cubic phase c-Li_{6.25}Al_{0.25}La₃Zr₂O₁₂, which was ground to a fine powder in a mortar for further processing.

The c-Li_{6.25}Al_{0.25}La₃Zr₂O₁₂ solid electrolyte pellets with relative densities of ˜87±3% made from this powder (sintered in a horizontal tube furnace at 1070° C. for 10 h under 02 atmosphere) exhibited an ionic conductivity of ˜0.5×10⁻³ S cm⁻¹ (RT). The garnet-type solid electrolyte with a composition of c-Li_{6.25}Al_{0.25}La₃Zr₂O₁₂ (LLZO) in a powder form was encapsulated in several ion-conducting polymers.

### EXAMPLE 4: Preparation of Sodium Superionic Conductor (NASICON) Type Inorganic Solid Electrolyte Powder

The Na_{3.1}Zr_{1.95}M_{0.05}Si₂PO₁₂ (M=Mg, Ca, Sr, Ba) materials were synthesized by doping with alkaline earth ions at octahedral 6-coordination Zr sites. The procedure employed consists of two sequential steps. Firstly, solid solutions of alkaline earth metal oxides (MO) and ZrO₂ were synthesized by high energy ball milling at 875 rpm for 2 h. Then NASICON Na_{3.1}Zr_{1.95}M_{0.05}Si₂PO₁₂ structures were synthesized through solid-state reaction of Na₂CO₃, Zr_{1.95}M_{0.05}O_{3.95}, SiO₂, and NH₄H₂PO₄ at 1260° C.

### EXAMPLE 5: Production of Bipolar Electrodes Comprising Poly(Vinylidene Fluoride)-Hexafluoropropylene (PVDF-HFP) as a Polymer Electrolyte and LGPS as the Inorganic Solid-State Electrolyte

PVDF-HFP is dissolvable in a liquid solvent such as N,N′-dimethylformamide (DMF), N-methylpyrrolidone (NMP), dimethyl sulfoxide (DMSO), and acetone. We chose to use a mixture of DMSO and acetone (1/1 volume ratio) to dissolve a lithium salt (LiPF₆) up to a mole ratio of 0.8 at 45° C. and to dissolve PVDF-HFP up to 3% by weight to obtain a polymer solution. Then, 5% by weight (relative to the intended total composite layer weight) of nano particles of an inorganic solid-state electrolyte (LGPS prepared in Example 2), 1% by weight of carbon nanotubes (CNTs), 1% reduced graphene oxide sheets (from Angstron Materials, Inc.), 10% by weight of PVDF-HVP/LiPF₆, and 83% by weight of lithium iron phosphate (LFP) particles were dispersed in the polymer solution to obtain a slurry having a solid content of 10% by weight. The slurry was slot-die coated onto a first primary surface of a graphene-coated Al foil and dried in a vacuum oven at 65° C. overnight to obtain a cathode layer-coated bipolar electrode. Several samples were prepared.

In one set of cathode layer-coated bipolar electrodes, the opposing primary surface of each electrode was left empty (without any anode active layer). Multiple bipolar electrodes (5 of them here) were then internally connected in series in such a manner that a polymer composite separator (specified below) was then disposed between a cathode layer of one bipolar electrode and an empty opposing primary surface of a neighboring bipolar electrode. Such a structure is a bipolar anodeless battery module.

In another set of samples, the second (opposing) primary surface of the graphene-coated Al foil was deposited with an anode layer comprising 83% of graphene-protected Si anode particles (from Honeycomb Battery Co., Dayton, Ohio), 2% by weight of carbon nanotubes (CNTs), 5% by weight of LGPS particles, and 10% by weight of PVDF-HVP/LiPF₆.

Further, specimens of a separator (solid-state electrolyte) comprising ⅓ of PVDF-HVP/LiPF₆ and ⅔ of LGPS particles were prepared in a similar manner, but no electrode active material and no electron-conducting additive were included. The multiple layers of bipolar electrodes and separator layers then alternately stacked (according to the sequence of FIG. 2(A)) and heated to 180° C. for 5 minutes under a pressure of 20 psi and subsequently cooled to room temperature to prepare a battery module. The anode, the separator, and the cathode layers in this module have the same PVDF-HFP-based polymer electrolyte.

A different set of bipolar modules were prepared by using a different type bipolar current collector. Instead of coating an anode layer on one primary surface and a cathode layer on the opposing primary surface of a graphene-protected Al foil, we coated a cathode layer on one primary surface (herein referred to as 1^{st} primary surface) of an Al foil, leaving the opposing or 2^{nd} surface “empty” (free from an anode layer), to obtain one half of a bipolar electrode. In addition, we coated an anode layer on one primary surface (3^{rd} primary surface) of a Cu foil, leaving the opposing (4^{th}) primary surface empty, to obtain the other half of the bipolar electrode. Then, we stack these two half electrodes, with the two empty surfaces matched and bonded together (2^{nd} surface mating 4^{th} surface), to produce a complete bipolar electrode. A plurality of bipolar electrodes were then stacked and bonded together, connected in series, to form a module, according to FIG. 2(A); in this case, a Cu foil and an Al foil were bonded together to become a bipolar current collector. Multiple bipolar modules were then connected in parallel to form a pack according to FIGS. 2(B) and 2(C).

### EXAMPLE 6: Production of Poly(Acrylonitrile)-Based NCM-622 Cathode Layer

Poly(acrylonitrile) (PAN) is soluble in polar solvents, such as dimethylformamide (DMF), dimethylacetamide (DMAc), ethylene carbonate (EC) and propylene carbonate (PC), and in aqueous solutions of sodium thiocyanate, zinc chloride or nitric acid. The present study primarily made use of DMAc and EC as a solvent. A lithium salt (LiPF₆) was dissolved in EC for up to a mole ratio of 1.2 at 45° C. On a separate basis, 5% by weight of PAN was dissolved in EC to make a polymer solution. The EC/LiPF₆ solution was then mixed with the EC/PAN solution to form a mixture solution. Nano particles of LLZO (obtained in Example 3), along with cathode active material particles (NCM-622) and graphene sheets (as a conductive additive), were then dispersed in the mixture solution to obtain a slurry having a solid content of 4.5%. The amounts of particles and additives were added for the purpose of reaching the following weight %: LLZO (8%), PAN (10%), graphene sheets (2%), and NCM-622 (80%) in the polymer composite. The slurry was coated onto a primary surface of a graphene-coated Al foil and dried to form a cathode layer.

A separate set of samples were prepared by using a conventional slurry coating procedure to produce a porous cathode layer on a first primary surface of a bipolar current collector. In this procedure, particles of LLZO, NCM-622 cathode material, graphene sheets, and PVDF (as a binder resin) were dispersed in NMP solvent to form a slurry. A layer of slurry was then coated on a surface of Al foil; upon drying a cathode layer was formed having pores. The same mixture solution of EC/PAN/LiPF₆ was then sprayed over the porous cathode layer, allowing the solution to permeate into pores. The solvent was then removed with heat and a vacuum pump, leaving behind PAN containing LiPF₆ dispersed therein.

### EXAMPLE 7: Bipolar Lithium Metal Battery Featuring an In Situ Polymerized VC or FEC as the First Liquid Solvent in an Anode Layer of a Bipolar Electrode

In one example, vinylene carbonate (VC) or fluoroethylene carbonate (FEC) as a first liquid solvent, TEP as a second liquid solvent (flame retardant), and poly(ethylene glycol) diacrylate (PEGDA) as a crosslinking agent were stirred under the protection of argon gas until a homogeneous solution was obtained. The TEP has the following chemical structure:

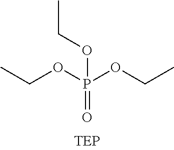

Subsequently, lithium hexafluoro phosphate, as a lithium salt, was added and dissolved in the above solution to obtain a reactive mixture solution, wherein the weight fractions of VC or FEC, TEP, polyethylene glycol diacrylate, and lithium hexafluoro phosphate were 80 wt %, 5 wt %, 10 wt %, and 5 wt %, respectively.

Particles of SiOₓ, particles of Li₇La₃Zr₂O₂, a conductive additive (multi-walled carbon nano-tubes), and one of the above reactive electrolyte solutions were mixed to form a reactive anode, which was coated on one primary surface of a graphene-coated Al foil (a product of Global Graphene Group. Inc., Dayton, Ohio). The other, opposing primary surface was already deposited with a cathode layer by following the procedure described in Example 5.

Layers of a solid-state electrolyte-based separator composed of particles of Li₇La₃Zr₂O₁₂ embedded in a polyvinylidene fluoride matrix (inorganic solid electrolyte/PVDF ratio=4/6) were then prepared. Three bipolar electrodes and two separators were then stacked together to form a bipolar lithium battery containing uncured liquid electrolyte in the anode layers.

The bipolar battery was then irradiated with electron beam at room temperature until a total dosage of 40 Gy was reached. In-situ polymerization of the polymerizable first liquid solvent in the battery cell was accomplished, resulting in a quasi-solid electrolyte that permeates into the anode to wet the surfaces of SiOₓ particles.

### EXAMPLE 8: Vinyl Ethylene Sulfite (VES) as the First Solvent and Hydrofluoro Ether (HFE) as the Second Solvent

Under the protection of an argon gas atmosphere, vinyl ethylene sulfite (VES), hydrofluoro ether (HFE), and tetra(ethylene glycol) diacrylates were stirred evenly to form a solution. Bis trifluoromethyl sulfimide lithium was then dissolved in the solution to obtain a solution mixture. In this solution mixture, the weight fractions for the four ingredients were VEC (40%), HFE (20%), tetra(ethylene glycol) diacrylates (20%), and bis trifluoromethyl sulfimide (10%).

The mixed solution was added to a bipolar lithium-ion battery having four unit cells connected in series; each having a cathode (comprising NCM-622, particles of inorganic electrolyte Na_{3.1}Zr_{1.95}M_{0.05}Si₂PO₁₂, CNTs as a conductive additive, and polyethylene oxide electrolyte, PEO) on one primary surface of an expanded graphite-coated Cu foil (prepared according to a procedure described in Example 6), a graphite anode on one primary surface of another expanded graphite-coated Cu foil, and a separator (a composite membrane comprising Na_{3.1}Zr_{1.95}M_{0.05}Si₂PO₁₂ and PEO). These bipolar electrodes and separators were assembled after the mixed solution was sprayed and impregnate into the negative electrodes (anodes); the mixed solution accounted for 3% of the total battery weight. The battery was exposed to electron beam at 50° C. until a dosage of 20 kGy was reached. VEC was polymerized and crosslinked to become a solid polymer, but HFE remained as a liquid.

### EXAMPLE 9: Lithium-Ion Cell Featuring an In Situ Polymerized Phenyl Vinyl Sulfide (PVS) in the Presence of a Second Solvent TMS (PVS/TMS Ratio=9/1-9/5)

TMS has the following chemical formula:

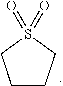

The bipolar lithium-ion battery modules prepared in this example each comprise five unit cells internally connected in series. Each bipolar electrode comprises a graphene composite-coated Al as a bipolar current collector. One primary surface was coated with a cathode layer of NCM-622 particles as obtained in Example 5.

The opposing primary surface of this current collector is coated with an anode layer of meso-carbon micro-beads (MCMB, an artificial graphite supplied from China Steel Chemical Co. Taiwan) and an SBR binder. This anode layer was prepared by following the well-known slurry coating, following by heat-drying to remove the liquid medium (water) to obtain a porous anode layer having pores.

Phenyl vinyl sulfide (first liquid solvent), TMS (second solvent), CTA (chain transfer agent, shown below), AIBN (initiator, 1.0%), and 5% by weight of lithium trifluoro-metasulfonate (LiCF₃SO₃), were mixed and impregnated into the porous anode layer, and heated at 60° C. to obtain a battery cell containing an in situ cued polymer electrolyte.

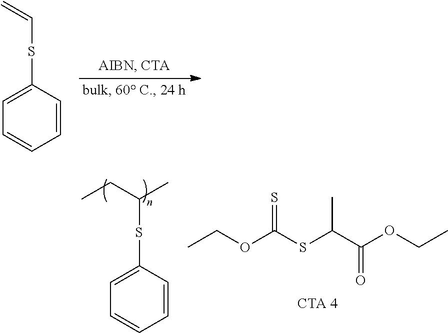

A porous PE/PP membrane impregnated with a reactive liquid electrolyte was used as a separator disposed between an anode layer of a bipolar electrode and a cathode layer of a neighboring bipolar electrode.

Three bipolar modules (each having 5 basic units connected internally in series) prepared in this manner were then connected in parallel to form a bipolar pack.

### EXAMPLE 10: Lithium-Ion Bipolar Battery Featuring an In Situ Polymerized Phenyl Vinyl Sulfone

The bipolar lithium-ion batteries prepared in this example each comprise 13 unit cells to deliver a battery output voltage of 48 volts. Each unit cell includes an anode layer made of graphene-protected Si particles, a porous PE/PP membrane as a separator, and a cathode of NCM-622 particles as prepared in Example 6. The anode layer was prepared via in-situ curing in a procedure similar to that in Example 9; but the polymer was PVS.

Phenyl vinyl sulfone (PVS) can be polymerized with several anionic-type initiators; e.g., n-BuLi, ZnEt2, LiN(CH₂)₂, and NaNH₂. The second solvent may be selected from pyridine, sulfolane, Trimethyl phosphate (TMP), Trifluoro-Phosphate (TFP), etc. Trimethyl phosphate has the following chemical structure:

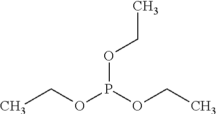

A mixture of PVS, TFP, n-BuLi (1.0% relative to PVS), and LiBF₄ (0.5 M) was thoroughly mixed and impregnated into the negative electrodes prior to stacking of bipolar electrodes and separators. The bipolar batteries were maintained at 30° C. overnight to cure the PVS solvent.

### EXAMPLE 11: Bipolar Battery Packs Containing Quasi-Solid and Solid-State Electrolytes from Vinylphosphonic Acid (VPA)

The free radical polymerization of vinylphosphonic acid (VPA) can be catalyzed with benzoyl peroxide as the initiator. In a representative procedure, 150 parts vinylphosphonic acid, 0.75 parts benzoyl peroxide, and 20 parts of lithium bis(oxalato)borate (LiBOB) were dissolved in 150 parts isopropanol. For the preparation of bipolar lithium batteries, dry bipolar electrodes were injected with the reactive mass, followed by removal of most of the isopropanol and, in some cases, replaced with TFP as a second solvent.

In a separate experiment, vinylphosphonic acid was heated to >45° C. (melting point of VPA=36° C.), which was added with benzoyl peroxide. LiBOB, and 25% by weight of a garnet-type solid electrolyte (Li₇La₃Zr₂O₁₂ (LLZO) powder). After rigorous stirring, the resulting paste was cast onto a glass surface and cured at 90° C. for 5 hours to form a solid electrolyte separator to be disposed between an anode and a cathode layer.

For a bipolar lithium-ion battery, a natural graphite-based anode and a LiCoO₂-based cathode were deposited onto the two primary surfaces of an expanded graphite-coated Al foil as a bipolar current collector. This was obtained by following a procedure similar to that in Example 5 (impregnating a polymer solution into pores of a dried cathode layer or anode layer, followed by solvent removal). For an anode-less lithium battery, a LiCoO₂-based cathode layer was deposited on one primary surface of the expanded graphite-coated Al foil, but the opposing primary surface was not deposited with any lithium metal. Multiple (10) bipolar electrodes and 9 solid electrolyte separator layers were assembled into a bipolar battery. The batteries were then heated for 5 hours at 90° C. to form polyvinylphosphonic acid, mixed with 5% by weight TFP.

Electrochemical measurements (CV curves) were carried out in an electrochemical workstation at a scanning rate of 1-100 mV/s. The electrochemical performance of the bipolar batteries were evaluated by galvanostatic charge/discharge cycling at a current density of 50-500 mA/g using an Arbin electrochemical workstation. Testing results indicate that the batteries containing quasi-solid or solid-state electrolytes obtained by in situ curing perform very well, having higher energy densities and power densities as compared to battery modules having conventional liquid electrolyte-based lithium cells connected in series via wires. These bipolar batteries are flame resistant and relatively safe.

### EXAMPLE 12: In Situ Cured Diethyl Vinylphosphonate and Diisopropyl Vinylphosphonate Polymer Electrolytes in a Bipolar Lithium/NCM-532 Battery (Initially the Cell being Lithium-Free) and a Bipolar Lithium-Ion Battery Containing a Si-Based Anode and an NCM-532 Cathode

Both diethyl vinylphosphonate and diisopropyl vinylphosphonate can be polymerized by a peroxide initiator (di-tert-butyl peroxide), along with LiBF₄, to clear, light-yellow polymers of low molecular weight. In a typical procedure, either 85% by weight of diethyl vinylphosphonate or diisopropyl vinylphosphonate (being a liquid at room temperature) and 5% of a second liquid solvent (unsaturated phosphazene) were added with di-tert-butyl peroxide (1% by weight) and LiBF₄ (9% by weight) to form a reactive electrolyte solution. The electrolyte solution was heated to 45° C. and mixed with anode active material particles (graphene-coated Si particle) and acetylene black particles to form an anode layer that is deposited on one primary surface of a current collector (for a lithium-ion battery). Bulk polymerization was allowed to proceed for 2-12 hours inside the anode.

A layer of cathode active material (NCM-522 particles) was made in a manner described in Example 6 (polymer solution impregnation into pores of a porous cathode layer, followed by removal of the liquid medium from the polymer solution) and coated onto the other primary surface of the same bipolar current collector. For the construction of an anode-less lithium metal battery, the anode side of the bipolar current collector was left open (without any anode active material).

Layers of diethyl vinylphosphonate and diisopropyl vinylphosphonate polymer electrolytes were cast on glass surfaces and polymerized for 3 hours. Bulk polymerization was allowed to proceed for 2-12 hours inside these layers. The lithium ion conductivity of these solid-state electrolytes was measured. The lithium ion conductivity of diethyl vinylphosphonate derived polymers was found to be in the range of 5.4×10⁻⁵ S/cm-7.3×10⁻⁴ S/cm and that of diisopropyl vinylphosphonate polymer electrolytes in the range of 6.6×10⁻⁵ S/cm-8.4×10⁻⁴ S/cm without a second solvent. Both are solid state electrolytes that are highly flame resistant. The presence of phosphazene liquid was found to increase the lithium ion conductivity by 3-5 times.

Multiple bipolar electrodes and layers of polymer electrolyte separator were stacked to form bipolar battery modules. Multiple modules were then internally connected in parallel to make a bipolar battery pack, which was encased in plastic-Al-plastic housing. In several samples, a garnet-type solid electrolyte (Li₇La₃Zr₂O₁₂ (LLZO) powder) was added into the cathode (NCM-532) in the anode-less lithium battery.

1. A bipolar battery pack comprising one or a plurality of modules wherein at least a first module comprises a first set of multiple bipolar electrodes internally connected in series, wherein at least one of said bipolar electrodes comprises:
(a) a current collector comprising a conductive material foil having a thickness from 10 nm to 100 μm and two opposing primary surfaces;
(b) a positive electrode layer disposed on one of the two primary surfaces, wherein the positive electrode layer comprises a mixture of particles of a cathode active material, and a first hybrid electrolyte comprising a mixture of an inorganic solid-state electrolyte and a solid polymer electrolyte or gel polymer electrolyte, wherein the solid polymer or gel polymer electrolyte comprises a polymer, having a lithium ion conductivity no less than 1.0×10⁻⁸ S/cm at room temperature, which is a product prepared by partially or totally removing a first liquid solvent from a polymer solution originally comprising a polymer and a lithium salt dissolved in said first liquid solvent having a polymer-to-lithium salt weight ratio of from 1/100 to 100/1; and
(c) either (i) a negative electrode layer deposited on the opposing primary surface wherein the negative electrode layer comprises a lithium metal layer or a layer of a mixture of particles of an anode active material and a solid polymer electrolyte or gel polymer electrolyte, wherein the solid or gel polymer comprises a lithium salt dispersed therein with a polymer-to-lithium salt weight ratio of from 1/100 to 100/1 or (ii) initially without a negative electrode layer deposited on said opposing primary surface when the battery pack is made;
wherein the multiple bipolar electrodes are connected in series in such a manner that an ion-permeable separator or solid-state electrolyte layer is disposed between the negative electrode layer of a bipolar electrode and the positive electrode layer of a neighboring bipolar electrode.

2. The bipolar battery pack of claim 1, wherein said pack further comprises at least a second module comprising a second set of multiple bipolar electrodes internally connected in series and said first module and said at least second module are internally connected in parallel.

3. The bipolar battery pack of claim 2, wherein said pack comprises a protecting housing that encloses said first module and said at least second module.

4. The bipolar battery pack of claim 1, wherein said solid polymer or gel polymer electrolyte and said inorganic solid-state electrolyte, in combination, form a contiguous phase in the cathode, the anode, or both the anode and the cathode, and the contiguous phase is in a physical contact or ionic communication with said ion-permeable separator or solid-state electrolyte layer.

5. The bipolar battery pack of claim 1, wherein the conductive material foil has one of the following features: (i) one or both of the primary surfaces of said conductive material foil is coated with a layer of graphene or expanded graphite material having a layer thickness from 1 nm to 50 μm or (ii) the conductive material foil comprises two or more layers of different conductive materials laminated together.

6. The bipolar battery pack of claim 1, wherein the first liquid solvent is selected from the group consisting of 1,2-dimethoxyethane (DME), tetraethylene glycol dimethylether (TEGDME), poly(ethylene glycol) dimethyl ether (PEGDME), diethylene glycol dibutyl ether (DEGDBE), 2-ethoxyethyl ether (EEE), sulfone, sulfolane, dimethyl carbonate (DMC), methylethyl carbonate (MEC), ethyl propionate, methyl propionate, propylene carbonate (PC), gamma.-butyrolactone (γ-BL), acetonitrile (AN), ethyl acetate (EA), propyl formate (PF), methyl formate (MF), toluene, xylene, methyl acetate (MA), fluoroethylene carbonate (FEC), vinylene carbonate (VC), allyl ethyl carbonate (AEC), vinylene carbonate, ethylene carbonate, fluoroethylene carbonate, vinyl sulfite, vinyl ethylene sulfite, vinyl ethylene carbonate, 1,3-propyl sultone, 1,3-acrylic-sultones, methyl ethylene sulfone, methyl vinyl sulfone, ethyl vinyl sulfone, methyl methacrylate, vinyl acetate, acrylamide, 1,3-dioxolane (DOL), fluorinated ethers, fluorinated esters, sulfones, sulfides, nitriles, sulfates, siloxanes, silanes, phosphates, phosphonates, phosphinates, phosphines, phosphine oxides, phosphonic acids, phosphorous acid, phosphites, phosphoric acids, phosphazene compounds, derivatives thereof, and combinations thereof.

7. The bipolar battery pack of claim 1, wherein the negative electrode layer with the lithium metal layer or layer of the mixture of particles of anode active material, further includes a second hybrid electrolyte, wherein the second hybrid electrolyte comprises a mixture of particles of an inorganic solid electrolyte and a second polymer electrolyte which meets one of the following two criteria:
(A) said second polymer electrolyte is a product prepared by partially or totally removing a second liquid solvent from a polymer solution originally comprising a second polymer and a lithium salt dissolved in said second liquid solvent having a polymer-to-lithium salt weight ratio of from 1/100 to 100/1; or
(B) said second polymer is a polymerization or crosslinking product of a reactive additive, wherein the reactive additive comprises (i) a third liquid solvent that is polymerizable, (ii) an initiator or a crosslinking or curing agent, and (iii) a lithium salt, wherein the third liquid solvent occupies from 1% to 99% by weight of the total weight of the reactive additive, wherein the third liquid solvent is the same as or different from the first liquid solvent;
wherein the second polymer has a lithium ion conductivity no less than 1.0×10⁻⁸ S/cm at room temperature and the second hybrid electrolyte is the same as or different from the first hybrid electrolyte.

8. The bipolar battery pack of claim 6, wherein the positive electrode layer or the negative electrode layer further comprises a second liquid solvent and the first liquid solvent has a lower flash point, a higher vapor pressure, a higher dielectric constant, or a higher solubility of the lithium salt as compared with the second liquid solvent.

9. The bipolar battery pack of claim 6, wherein the first liquid solvent comprises a flame retardant selected from an organic phosphorus compound, an inorganic phosphorus compound, a halogenated derivative thereof, or a combination thereof.

10. The bipolar battery pack of claim 9, wherein the organic phosphorus compound or the inorganic phosphorus compound is selected from the group consisting of phosphates, phosphonates, phosphonic acids, phosphorous acids, phosphites, phosphoric acids, phosphinates, phosphines, phosphine oxides, phosphazene compounds, derivatives thereof, and combinations thereof.

11. The bipolar battery pack of claim 1, wherein said solid polymer electrolyte or gel polymer electrolyte comprises a polymer selected from poly(ethylene oxide), polypropylene oxide, polyoxymethylene, polyvinylene carbonate, polypropylene carbonate, poly(ethylene glycol), poly(acrylonitrile), poly(methyl methacrylate), poly(vinylidene fluoride), poly bis-methoxy ethoxyethoxide-phosphazenex, polyvinyl chloride, polydimethylsiloxane, poly(vinylidene fluoride)-hexafluoropropylene, cyanoethyl poly(vinyl alcohol), a pentaerythritol tetra-acrylate-based polymer, an aliphatic polycarbonate, a single Li-ion conducting solid polymer, poly(ethylene glycol) diacrylate, poly(ethylene glycol) methyl ether acrylate, polyurethane, polyurethane-urea, polyacrylamide, a polyionic liquid, polymerized 1,3-dioxolane, polyepoxide ether, polysiloxane, poly(acrylonitrile-butadiene), polynorbornene, poly(hydroxyl styrene), poly(ether ether ketone), polypeptoid, poly(ethylene-maleic anhydride), polycaprolactone, poly(trimethylene carbonate), polyphosphate, polyphosphonate, polyphosphinate, polyphosphine, polyphosphine oxide, a polymer synthesized from an ionic liquid, a copolymer thereof, a semi-penetrating network thereof, a sulfonated derivative thereof, or a combination thereof.

12. The bipolar battery pack of claim 1, wherein said inorganic solid electrolyte is selected from an oxide type, sulfide type, hydride type, halide type, borate type, phosphate type, lithium phosphorus oxynitride (LiPON), garnet-type, lithium superionic conductor (LISICON) type, sodium superionic conductor (NASICON) type, or a combination thereof.

13. The bipolar battery pack of claim 1, wherein the first hybrid electrolyte further comprises a second solvent and wherein the first or the second liquid solvent is selected from a phosphate, phosphonate, phosphinate, phosphine, or phosphine oxide having the structure of: 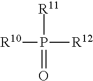
wherein R¹⁰, R¹¹, and R¹², are independently selected from the group consisting of alkyl, aryl, heteroalkyl, heteroaryl, halogen substituted alkyl, halogen substituted aryl, halogen substituted heteroalkyl, halogen substituted heteroaryl, alkoxy, aryloxy, heteroalkoxy, heteroaryloxy, halogen substituted alkoxy, halogen substituted aryloxy, halogen substituted heteroalkoxy, and halogen substituted heteroaryloxy functional groups, and the second liquid solvent is stable under an applied electrical potential no less than 4 V.

14. The bipolar battery pack of claim 1, wherein the first hybrid electrolyte further comprises a second solvent and wherein the first or the second liquid solvent comprises a phosphoranimine having the structure of: 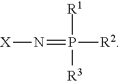
wherein R¹, R², and R³ are independently selected from the group consisting of alkyl, aryl, heteroalkyl, heteroaryl, halogen substituted alkyl, halogen substituted aryl, halogen substituted heteroalkyl, halogen substituted heteroaryl, alkoxy, aryloxy, heteroalkoxy, heteroaryloxy, halogen substituted alkoxy, halogen substituted aryloxy, halogen substituted heteroalkoxy, and halogen substituted heteroaryloxy functional groups, wherein R¹, R², and R³ are represented by at least two different substituents and wherein X is selected from the group consisting of an organosilyl group or a tert-butyl group.

15. The bipolar battery pack of claim 14, wherein R¹, R², and R³ are each independently selected from the group consisting of an alkoxy group, and an aryloxy group.

16. The bipolar battery pack of claim 1, wherein the first liquid solvent is selected from a fluorinated carbonate, hydrofluoroether, fluorinated ester, sulfone, nitrile, phosphate, phosphite, alkyl phosphonate, phosphazene, sulfate, siloxane, silane, 1,3-dioxolane (DOL), 1,2-dimethoxyethane (DME), tetraethylene glycol dimethylether (TEGDME), poly(ethylene glycol) dimethyl ether (PEGDME), diethylene glycol dibutyl ether (DEGDBE), 2-ethoxyethyl ether (EEE), sulfone, sulfolane, dimethyl carbonate (DMC), methylethyl carbonate (MEC), ethyl propionate, methyl propionate, propylene carbonate (PC), gamma.-butyrolactone (γ-BL), acetonitrile (AN), ethyl acetate (EA), propyl formate (PF), methyl formate (MF), toluene, xylene, methyl acetate (MA), fluoroethylene carbonate (FEC), allyl ethyl carbonate (AEC), or a combination thereof.

17. The bipolar battery pack of claim 1, wherein the first liquid solvent is selected from the group consisting of fluorinated vinyl carbonates, fluorinated vinyl monomers, fluorinated esters, fluorinated vinyl esters, and fluorinated vinyl ethers and combinations thereof.

18. The bipolar battery pack of claim 1, wherein the first hybrid electrolyte further comprises a second solvent and the first or the second liquid solvent comprises a sulfone or sulfide selected from vinyl sulfone, allyl sulfone, alkyl vinyl sulfone, aryl vinyl sulfone, vinyl sulfide, TrMS, MTrMS, TMS, EMS, MMES, EMES, EMEES, or a combination thereof:

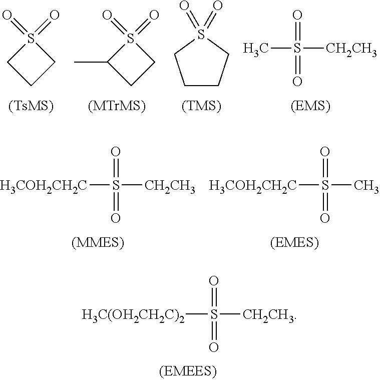

19. The bipolar battery pack of claim 18, wherein the vinyl sulfone or sulfide is selected from ethyl vinyl sulfide, allyl methyl sulfide, phenyl vinyl sulfide, phenyl vinyl sulfoxide, allyl phenyl sulfone, allyl methyl sulfone, divinyl sulfone, or a combination thereof, wherein the vinyl sulfone does not include methyl ethylene sulfone and ethyl vinyl sulfone.

20. The bipolar battery pack of claim 1, wherein the first liquid solvent comprises a nitrile, a dinitrile selected from AND, GLN, SEN, SN, or a combination thereof:

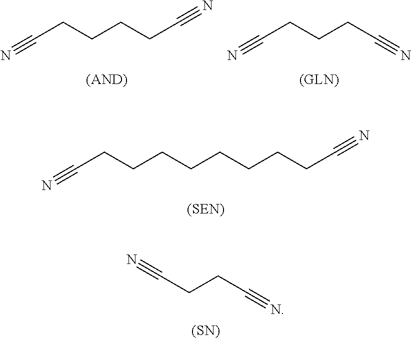

21. The bipolar battery pack of claim 1, wherein the first liquid solvent comprises a phosphate selected from allyl-type, vinyl-type, styrenic-type and (meth)acrylic-type monomers bearing a phosphonate moiety.

22. The bipolar battery pack of claim 1, wherein the first hybrid electrolyte further comprises a second solvent and the first or the second liquid solvent comprises a phosphate, phosphonate, phosphonic acid, phosphazene, or phosphite selected from TMP, TEP, TFP, TDP, DPOF, DMMP, DMMEMP, tris(trimethylsilyl)phosphite (TTSPi), alkyl phosphate, triallyl phosphate (TAP), or a combination thereof, wherein TMP, TEP, TFP, TDP, DPOF, DMMP, DMMEMP, and phosphazene have the following chemical formulae: 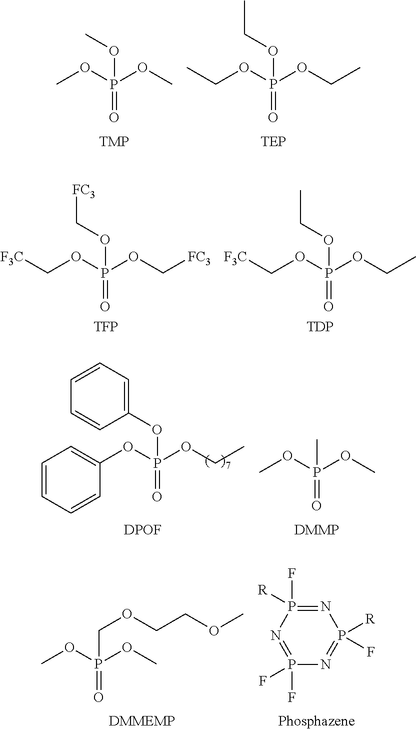
wherein R═H, NH₂, or C₁-C₆ alkyl.

23. The bipolar battery pack of claim 1, wherein the hybrid electrolyte further comprises a second solvent and the first or the second liquid solvent comprises siloxane or silane selected from alkylsiloxane (Si—O), alkyylsilane (Si—C), liquid oligomeric silaxane (—Si—O—Si—), or a combination thereof.

24. The bipolar battery pack of claim 7, wherein the reactive additive further comprises an amide group selected from N,N-dimethylacetamide, N,N-diethylacetamide, N,N-dimethylformamide, N,N-diethylformamide, or a combination thereof.

25. The bipolar battery pack of claim 7, wherein the crosslinking agent comprises a compound having at least one reactive group selected from a hydroxyl group, an amino group, an imino group, an amide group, an acrylic amide group, an amine group, an acrylic group, an acrylic ester group, or a mercapto group in the molecule.

26. The bipolar battery pack of claim 7, wherein the crosslinking agent is selected from poly(diethanol) diacrylate, poly(ethyleneglycol)dimethacrylate, poly(diethanol) dimethylacrylate, poly(ethylene glycol) diacrylate, or a combination thereof.

27. The bipolar battery pack of claim 7, wherein said initiator is selected from an azo compound, azobisisobutyronitrile, azobisisoheptonitrile, dimethyl azobisisobutyrate, benzoyl peroxide tert-butyl peroxide and methyl ethyl ketone peroxide, benzoyl peroxide (BPO), bis(4-tert-butylcyclohexyl)peroxydicarbonate, t-amyl peroxypivalate, 2,2′-azobis-(2,4-dimethylvaleronitrile), 2,2′-azobis-(2-methylbutyronitrile), 1,1-azobis(cyclohexane-1-carbonitrile, benzoylperoxide (BPO), hydrogen peroxide, dodecamoyl peroxide, isobutyryl peroxide, cumene hydroperoxide, tert-butyl peroxypivalate, diisopropyl peroxydicarbonate, lithium hexafluorophosphate (LiPF₆), lithium borofluoride (LiBF₄), lithium hexafluoroarsenide (LiAsF₆), lithium trifluoro-metasulfonate (LiCF₃SO₃), bis-trifluoromethyl sulfonylimide lithium (LiN(CF₃SO₂)₂), lithium bis(oxalato)borate (LiBOB), lithium oxalyldifluoroborate (LiBF₂C₂O₄), lithium oxalyldifluoroborate (LiBF₂C₂O₄), or a combination thereof.

28. The bipolar battery pack of claim 1, wherein said lithium salt is selected from lithium perchlorate (LiClO₄), lithium hexafluorophosphate (LiPF₆), lithium borofluoride (LiBF₄), lithium hexafluoroarsenide (LiAsF₆), lithium trifluoro-metasulfonate (LiCF₃SO₃), bis-trifluoromethyl sulfonylimide lithium (LiN(CF₃SO₂)₂), lithium bis(oxalato)borate (LiBOB), lithium oxalyldifluoroborate (LiBF₂C₂O₄), lithium oxalyldifluoroborate (LiBF₂C₂O₄), lithium nitrate (LiNO₃), Li-Fluoroalkyl-Phosphates (LiPF₃(CF₂CF₃)₃), lithium bisperfluoro-ethysulfonylimide (LiBETI), lithium bis(trifluoromethanesulphonyl)imide, lithium bis(fluorosulphonyl)imide, lithium trifluoromethanesulfonimide (LiTFSI), an ionic liquid lithium salt, or a combination thereof.

29. The bipolar battery pack of claim 1, wherein said ion-permeable separator or solid-state electrolyte layer is selected from a porous polymer membrane, a porous ceramic membrane, a porous glass membrane, a solid polymer electrolyte layer, an inorganic solid-state electrolyte layer, a composite solid-state electrolyte layer comprising particles of an inorganic solid bonded by a polymer or dispersed in a polymer, or a combination thereof.

30. The bipolar battery pack of claim 1, wherein the positive electrode or cathode comprises a cathode active material selected from lithium nickel manganese oxide (LiNiₐMn₂₋ₐO₄, 0<a<2), lithium nickel manganese cobalt oxide (LiNiₙMnₘCo₁₋ₙ₋ₘO₂, 0<n<1, 0<m<1, n+m<1), lithium nickel cobalt aluminum oxide (LiNi_{c}Co_{d}Al_{1-c-d}O₂, 0<c<1, 0<d<1, c+d<1), lithium manganate (LiMn₂O₄), lithium iron phosphate (LiFePO₄), lithium manganese oxide (LiMnO₂), lithium cobalt oxide (LiCoO₂), lithium nickel cobalt oxide (LiNiₚCo₁₋ₚO₂, 0<p<1), or lithium nickel manganese oxide (LiNi_{q}Mn_{2-q}O₄, 0<q<2), sulfur (S), lithium sulfide (LiₓS, x=1-8), a sulfur-containing compound, selenium (Se), lithium selenide (LiₓS, x=1-8), a selenium-containing compound, or a combination thereof.

31. The bipolar battery pack of claim 1, wherein the negative electrode layer comprises an anode active material selected from the group consisting of: (a) silicon (Si), germanium (Ge), tin (Sn), lead (Pb), antimony (Sb), phosphorus (P), bismuth (Bi), zinc (Zn), aluminum (Al), titanium (Ti), nickel (Ni), cobalt (Co), and cadmium (Cd); (b) alloys or intermetallic compounds of Si, Ge, Sn, Pb, Sb, Bi, Zn, Al, Ti, Ni, Co, or Cd with other elements; (c) oxides, carbides, nitrides, sulfides, phosphides, selenides, and tellurides of Si, Ge, Sn, Pb, Sb, Bi, Zn, Al, Ti, Fe, Ni, Co, V, or Cd, and their mixtures, composites, or lithium-containing composites; (d) salts and hydroxides of Sn; (e) lithium titanate, lithium manganate, lithium aluminate, lithium titanium niobate, lithium-containing titanium oxide, lithium transition metal oxide, ZnCo₂O₄; (f) carbon or graphite particles (g) prelithiated versions thereof; and (h) combinations thereof.

32. The bipolar battery pack of claim 1, which is a lithium metal secondary battery, a lithium-ion battery, a lithium-sulfur battery, a lithium-ion sulfur battery, a lithium-selenium battery, or a lithium-air battery.

33. A method of producing the bipolar battery pack of claim 1, the method comprising:
a. Providing a first set of multiple bipolar electrodes and at least one layer or multiple layers of ion-permeable separator or solid-state electrolyte, wherein at least one of said bipolar electrodes is prepared by: (A) providing a current collector comprising a conductive material foil having a thickness from 10 nm to 100 μm and two opposing primary surfaces; (B) depositing a positive electrode layer on a first primary surface, wherein the positive electrode layer comprises a mixture of particles of a cathode active material, an optional conductive additive, an optional binder resin, particles of a solid inorganic solid-state electrolyte, and a first polymer electrolyte; and (C) providing either (i) a negative electrode layer deposited on the opposing primary surface wherein the negative electrode layer comprises a lithium metal layer or a layer of a mixture of particles of an anode active material, an optional conductive additive, an optional binder resin, optional particles of a solid inorganic solid-state electrolyte, and a second polymer electrolyte or (ii) initially no negative electrode layer deposited on said opposing primary surface;
b. Stacking the multiple bipolar electrodes sequentially with said layers of ion-permeable separator or solid-state electrolyte to connect multiple bipolar electrodes in series to form a module in such a manner that a layer of ion-permeable separator or solid-state electrolyte is disposed between the negative electrode layer of a bipolar electrode and the positive electrode layer of a neighboring bipolar electrode; and
c. Optionally encasing the module with a protective housing element to form a pack.

34. The method of claim 33, wherein step b) further comprises forming at least another module in a similar manner and connecting the resulting multiple modules in parallel, and step c) comprises encasing the parallel-connected multiple modules with a protective housing element to form a pack.

35. The method of claim 33, wherein the positive electrode layer in step a) is produced by (i) mixing and dispersing particles of a cathode active material, particles of a solid inorganic solid-state electrolyte, an optional resin binder, and an optional conductive additive in a liquid medium to form a liquid slurry; (ii) depositing a layer of slurry on the first primary surface of the current collector, (iii) removing the liquid medium from the slurry layer to obtain a porous positive electrode layer containing from 1% to 50% by volume of pores; (iv) preparing a first polymer solution comprising a polymer and a lithium salt dissolved in a first liquid solvent having a polymer-to-lithium salt weight ratio of from 1/100 to 100/1, wherein the polymer has a lithium-ion conductivity no less than 10⁻⁸ S/cm; and (v) impregnating the polymer solution into pores of the porous positive electrode layers and partially or totally removing the first liquid solvent from the positive electrode layer to obtain the bipolar electrode.

36. The method of claim 33, wherein the positive electrode layer in step a) is produced by (i) mixing, dispersing, or dissolving particles of a cathode active material, particles of a solid inorganic solid-state electrolyte, an optional resin binder, an optional conductive additive, and a first electrolyte polymer in a first liquid solvent to form a liquid slurry, wherein the first electrolyte polymer has a lithium-ion conductivity no less than 10⁻⁸ S/cm; (ii) depositing a layer of slurry on the first primary surface of the current collector; and (iii) partially or completely removing the first liquid solvent from the slurry layer to obtain the positive electrode layer.

37. The method of claim 33, wherein the negative electrode layer in step a) is produced by (i) mixing and dispersing particles of an anode active material, optional particles of a solid inorganic solid-state electrolyte, an optional resin binder, and an optional conductive additive in a liquid medium to form a liquid slurry; (ii) depositing a layer of slurry on a second primary surface of the current collector; (iii) removing the liquid medium from the slurry layer to obtain the negative electrode layer containing from 1% to 50% by volume of pores; and (iv) impregnating the pores with a polymer electrolyte.

38. The method of claim 33, wherein the negative electrode layer in step a) is produced by (i) mixing, dispersing, or dissolving particles of an anode active material, optional particles of a solid inorganic solid-state electrolyte, an optional resin binder, an optional conductive additive, and a electrolyte polymer in a liquid solvent to form a liquid slurry; (ii) depositing a layer of slurry on the opposing primary surface of the current collector, and (iii) partially or completely removing the liquid solvent from the slurry layer to obtain the negative electrode layer.

39. The method of claim 33, wherein the negative electrode layer in step a) is produced by (i) depositing a reactive anode layer onto a second primary surface of the current collector to form a reactive anode layer-coated current collector, wherein the reactive anode layer comprises a mixture of multiple particles of an anode active material, an optional conductive additive, and a reactive liquid electrolyte composition comprising at least a polymerizable first liquid solvent, a lithium salt dissolved in the first liquid solvent, and a crosslinking agent and/or an initiator, wherein the first liquid solvent occupies from 1% to 99% by weight based on the total weight of the reactive liquid electrolyte composition; and (ii) partially or totally polymerizing the first liquid solvent to obtain an anode active layer coated on the current collector wherein from 30% to 100% by weight of the polymerizable first liquid solvent is polymerized to become a quasi-solid or solid-state electrolyte that chemically bonds the multiple particles of the anode active material and the conductive additive together to form an anode active layer that adheres to the second primary surface.

40. The method of claim 39, wherein the first polymerizable liquid solvent is selected from the group consisting of vinylene carbonate, ethylene carbonate, fluoroethylene carbonate, vinyl sulfite, vinyl ethylene sulfite, vinyl ethylene carbonate, 1,3-propyl sultone, 1,3-acrylic-sultones, methyl ethylene sulfone, methyl vinyl sulfone, ethyl vinyl sulfone, methyl methacrylate, vinyl acetate, acrylamide, 1,3-dioxolane (DOL), fluorinated ethers, fluorinated esters, sulfones, sulfides, nitriles, sulfates, siloxanes, silanes, phosphates, phosphonates, phosphinates, phosphines, phosphine oxides, phosphonic acids, phosphorous acid, phosphites, phosphoric acids, phosphazene compounds, derivatives thereof, and combinations thereof.

41. The method of claim 33, wherein the first liquid solvent is selected from the group consisting of vinylene carbonate, ethylene carbonate, fluoroethylene carbonate, vinyl sulfite, vinyl ethylene sulfite, vinyl ethylene carbonate, 1,3-propyl sultone, 1,3-acrylic-sultones, methyl ethylene sulfone, methyl vinyl sulfone, ethyl vinyl sulfone, methyl methacrylate, vinyl acetate, acrylamide, 1,3-dioxolane (DOL), fluorinated ethers, fluorinated esters, sulfones, sulfides, nitriles, sulfates, siloxanes, silanes, phosphates, phosphonates, phosphinates, phosphines, phosphine oxides, phosphonic acids, phosphorous acid, phosphites, phosphoric acids, phosphazene compounds, derivatives thereof, and combinations thereof.

42. The method of claim 33, wherein steps (a) is conducted in a roll-to-roll manner, followed by cutting and slitting the bipolar electrodes into desired shapes and dimensions.

43. A method of producing the bipolar battery pack of claim 1, the method comprising:
a. Providing a first set of multiple bipolar electrodes and at least one layer or multiple layers of ion-permeable separator or solid-state electrolyte, wherein at least one of said bipolar electrodes is prepared by: (A) providing a first current collector comprising a first conductive material foil having a thickness from 10 nm to 100 μm and two opposing primary surfaces, herein after referred to as the first primary surface and the second primary surface, respectively; (B) depositing a positive electrode layer on the first primary surface to form a first half of the bipolar electrode, wherein the positive electrode layer comprises a mixture of particles of a cathode active material, an optional conductive additive, an optional binder resin, particles of a solid inorganic solid-state electrolyte, and a first polymer electrolyte and wherein the second surface is not deposited with a positive electrode layer or negative electrode layer, and (C) providing a second current collector comprising a second conductive material foil, different than the first conductive material, having a thickness from 10 nm to 100 μm and two opposing primary surfaces, herein after referred to as the third primary surface and the fourth primary surface, respectively; and (D) either depositing a negative electrode layer on the third primary surface or initially having no negative electrode layer deposited on said third primary surface to obtain a second half of the bipolar electrode, wherein the negative electrode layer comprises (i) a lithium metal layer and/or (ii) a layer of a mixture of particles of an anode active material, an optional conductive additive, an optional binder resin, optional particles of a solid inorganic solid-state electrolyte, and a second polymer electrolyte, and wherein the fourth surface is not deposited with a positive electrode layer or a negative electrode layer; and (E) combining the first half of the bipolar electrode and the second half of the bipolar electrode to form said bipolar electrode wherein the second primary surface and the fourth primary surface are mechanically compressed or chemically bonded together;
b. Stacking the multiple bipolar electrodes sequentially with said layers of ion-permeable separator or solid-state electrolyte to connect multiple bipolar electrodes in series to form a module in such a manner that a layer of ion-permeable separator or solid-state electrolyte is disposed between the negative electrode layer of a bipolar electrode and the positive electrode layer of a neighboring bipolar electrode; and
c. Optionally encasing the module with a housing element to form a pack.

44. The method of claim 43, wherein step b) further comprises forming at least another module in a similar manner and connecting the resulting multiple modules in parallel, and step c) comprises encasing the parallel-connected multiple modules with a protective housing element to form a pack.

45. The bipolar battery pack of claim 1, wherein the positive electrode layer further includes a conductive additive and a binder resin.

46. The bipolar battery pack of claim 1, wherein the negative electrode layer further includes a conductive additive and a binder resin.

47. The bipolar battery pack of claim 1, wherein the negative electrode layer further includes particles of a solid inorganic solid-state electrolyte.
